(19) United States
(12) Patent Application Publication
(10) Pub. No.: US 2015/0113401 A1
(43) Pub. Date: Apr. 23, 2015

(54) Method and Apparatus for Rendering of a Media Item

(71) Applicant: Nokia Corporation, Espoo (FI)

(72) Inventors: Arto Juhani Lehtiniemi, Lempaala (FI); Lasse Juhani Laaksonen, Nokia (FI); Miikka Tapani Vilermo, Siuro (FI); Mikko Tapio Tammi, Tampere (FI)

(21) Appl. No.: 14/061,608

(22) Filed: Oct. 23, 2013

(51) Int. Cl. G06F 3/0484

(52) U.S. Cl. CPC G06F 3/0484
USPC 715/716

(57) ABSTRACT

A method comprising determining that a first separate apparatus is proximate to the apparatus, receiving information indicative of a first media item candidate from the first separate apparatus, such that the first media item is associated with the first separate apparatus, determining that a second separate apparatus is proximate to the apparatus, receiving information indicative of a second media item candidate from the second separate apparatus, such that the second media item is associated with the second separate apparatus, determining a rendering media item based, at least in part, on the first media item candidate and the second media item candidate, and causing rendering of the rendering media item is disclosed.

### TECHNICAL FIELD

The present application relates generally to rendering of a media item.

### BACKGROUND

Many users utilize electronic apparatuses to manage and/or supplement various aspects of their lives. For example, many users listen to music, view images, and/or watch videos on their electronic apparatus. In addition, many users utilize electronic apparatuses for communication information, sharing information, and/or the like. It may be desirable to allow users to interact with electronic apparatuses in a simple and intuitive manner.

### SUMMARY

Various aspects of examples of the invention are set out in the claims.

One or more embodiments may provide an apparatus, a computer readable medium, a non-transitory computer readable medium, a computer program product, and a method for determining that a first separate apparatus is proximate to the apparatus, receiving information indicative of a first media item candidate from the first separate apparatus, such that the first media item is associated with the first separate apparatus, determining that a second separate apparatus is proximate to the apparatus, receiving information indicative of a second media item candidate from the second separate apparatus, such that the second media item is associated with the second separate apparatus, determining a rendering media item based, at least in part, on the first media item candidate and the second media item candidate, and causing rendering of the rendering media item.

One or more embodiments may provide an apparatus, a computer readable medium, a computer program product, and a non-transitory computer readable medium having means for determining that a first separate apparatus is proximate to the apparatus, means for receiving information indicative of a first media item candidate from the first separate apparatus, such that the first media item is associated with the first separate apparatus, means for determining that a second separate apparatus is proximate to the apparatus, means for receiving information indicative of a second media item candidate from the second separate apparatus, such that the second media item is associated with the second separate apparatus, means for determining a rendering media item based, at least in part, on the first media item candidate and the second media item candidate, and means for causing rendering of the rendering media item.

In at least one example embodiment, the first media item candidate being associated with the first separate apparatus relates to establishment of an association between the first media item candidate and a first separate apparatus identifier that identifies the first separate apparatus.

One or more example embodiments further perform determination of at least one media item selection criteria.

In at least one example embodiment, the media item selection criteria relates to designation of a constraint on selection of a media item candidate based, at least in part, on metadata associated with the media item candidate.

In at least one example embodiment, determination of the rendering media item is based, at least in part, on the media item selection criteria.

One or more example embodiments further perform sending of information indicative of the media item selection criteria to the first separate apparatus and the second separate apparatus, wherein the first media item candidate and the second media item candidate satisfy the media item selection criteria.

In at least one example embodiment, the sending of information indicative of the media item selection criteria to the first separate apparatus causes the first separate apparatus to constrain the first media item candidate to a media item candidate that satisfies the media item selection criteria.

One or more example embodiments further perform receiving of information indicative of a media item selection criteria designation.

In at least one example embodiment, the information indicative of a media item selection criteria designation relates to information received from one or more input devices.

In at least one example embodiment, the information indicative of a media item selection criteria designation relates to information received from at least one of the first separate apparatus or the second separate apparatus.

One or more example embodiments further perform determination of a first host media item candidate.

In at least one example embodiment, the determination of the rendering media item is further based, at least in part, on the first host media candidate.

One or more example embodiments further perform causation of rendering of the first host media item candidate.

One or more example embodiments further perform determination that a host rendering break point has been satisfied, wherein the determination of the rendering media item based, at least in part, on the first media item candidate and the second media item candidate is caused by the determination that the host rendering break point has been satisfied.

In at least one example embodiment, the host rendering breakpoint relates to a criteria that designates a condition to be satisfied for the apparatus to cause rendering of a non-host media item candidate.

In at least one example embodiment, the non-host media item candidate relates to a media item candidate received from a separate apparatus.

In at least one example embodiment, the host rendering break point relates to a number of host media item candidates to be rendered prior to causation of rendering of the non-host media item candidate.

In at least one example embodiment, the host rendering break point relates to a duration for rendering host media item candidates prior to causation of rendering of the non-host media item candidate.

One or more example embodiments further perform determination that a non-host rendering break point has been satisfied, wherein the causation of rendering of the first host media item candidate is caused by the determination that the non-host rendering break point has been satisfied.

In at least one example embodiment, the host rendering breakpoint relates to a criteria that designates a condition to be satisfied for the apparatus to cause termination of rendering of a non-host media item candidate.

In at least one example embodiment, the non-host rendering break point relates to a number of non-host media item candidates to be rendered prior to termination of rendering of the non-host media item candidate.

In at least one example embodiment, the non-host rendering break point relates to a duration for rendering non-host media item candidates prior to termination of rendering of the non-host media item candidate.

One or more example embodiments further perform determination that rendering of the rendering media item has completed, wherein termination of rendering of the non-host media item candidate is subsequent to the determination that rendering of the rendering media item has completed.

In at least one example embodiment, the determination that the first separate apparatus is proximate to the apparatus comprises determination that a distance from the apparatus to the first separate apparatus satisfies an apparatus proximity threshold.

In at least one example embodiment, the apparatus proximity threshold relates to a distance within which the apparatus determines a separate apparatus to be proximate.

One or more example embodiments further perform determination that a number of media item candidates satisfies a rendering initiation threshold, wherein the determination of the rendering media item is caused by the determination that the number of media item candidates satisfies the rendering initiation threshold.

In at least one example embodiment, the number of media item candidates is based, at least in part, on the first media item candidate and the second media item candidate.

In at least one example embodiment, the number of media item candidates includes increments associated with the first media item candidate and the second media item candidate.

In at least one example embodiment, determination of the rendering media item comprises determination that the rendering media item relates to the first media item candidate based, at least in part, on the association between the first media item candidate and the first separate apparatus.

One or more example embodiments further perform causation of communication of a notification to the first separate apparatus based, at least in part, on the determination that the rendering media item relates to the first media item candidate and the association between the first media item candidate and the first separate apparatus.

In at least one example embodiment, determination that the rendering media item relates to the first media item candidate is further based, at least in part, on a first distance indicative of a distance between the first separate apparatus and the apparatus.

In at least one example embodiment, determination that the rendering media item relates to the first media item candidate is further based, at least in part, on the first distance being less than a second distance that is indicative of a distance between the second separate apparatus and the apparatus.

One or more example embodiments further perform determination that the second distance has become less than the first distance, determination that rendering of the rendering media item has completed, determination of a second rendering media item to relate to the second media item candidate based, at least in part, on the association between the second media item candidate and the second separate apparatus and the second distance being less than the first distance, and causation of rendering of the second rendering media item.

One or more example embodiments further perform determination that rendering of the rendering media item has completed, determination of a second rendering media item to relate to the second media item candidate based, at least in part, on the rendering media item and the association between the second media item candidate and the second separate apparatus, and causation of rendering of the second rendering media item.

One or more example embodiments further perform determination of an apparatus order list that is indicative of an apparatus sequence, wherein the determination of the rendering media item is further based, at least in part, on the apparatus sequence correlating with the first separate apparatus and the determination of the second rendering media item is further based, at least in part, on the apparatus sequence correlating with the second separate apparatus.

In at least one example embodiment, the apparatus order list relates to a list that indicates a sequence of media items to be rendered based, at least in part, on correlation of the media items to an apparatus designated by the apparatus order list.

In at least one example embodiment, determination of the apparatus order list is based, at least in part, on a predetermined apparatus order.

In at least one example embodiment, the predetermined apparatus order relates to an apparatus order list having predetermined ordering of apparatuses for purposes of rendering media item selection.

One or more example embodiments further perform comprising receipt of information indicative of the predetermined apparatus order.

In at least one example embodiment, the information indicative of the predetermined apparatus order relates to one or more inputs.

In at least one example embodiment, the predetermined apparatus order is received from at least one of memory, a repository, or a separate apparatus.

In at least one example embodiment, determination of the apparatus order list is based, at least in part, on a ranking of distance between the apparatus and a separate apparatus represented in the apparatus order list.

In at least one example embodiment, determination of the apparatus order list comprises an indication of the second separate apparatus subsequent to the first separate apparatus based, at least in part, on a distance from the apparatus to the first separate apparatus being less than a distance from the apparatus to the second separate apparatus.

In at least one example embodiment, determination of the apparatus order list comprises an indication of a third separate apparatus subsequent to the second separate apparatus based, at least in part, on a distance from the first separate apparatus to the second separate apparatus being less than a distance from the first separate apparatus to the third separate apparatus.

In at least one example embodiment, the indication of the second separate apparatus subsequent to the first separate apparatus is further based, at least in part, on the first separate apparatus and the second separate apparatus being in a predetermined direction from the apparatus.

One or more example embodiments further perform receipt of information indicative of a change of the apparatus order list, determination of a different apparatus order list based, at least in part, on the change of the apparatus order list, and determination of a third rendering media item based, at least in part, on the different apparatus order list.

In at least one example embodiment, the information indicative of the change of the apparatus order list is received from a separate apparatus.

In at least one example embodiment, the change of the apparatus order list relates to skipping of a third separate apparatus such that the different apparatus order list comprises an indication of a fourth separate apparatus subsequent and adjacent to the second separate apparatus.

In at least one example embodiment, the information indicative of the change of the apparatus order list relates to skipping of the third separate apparatus.

In at least one example embodiment, the change of the apparatus order list relates to a reversal of the apparatus order list from a position of the apparatus order list.

In at least one example embodiment, the information indicative of the change of the apparatus order list relates to a reversal from the third separate apparatus, and the different apparatus order list comprises an indication of the first separate apparatus subsequent to the second separate apparatus.

In at least one example embodiment, the apparatus order list relates to indication of a predetermined number of media items associated with an apparatus associated with the media items in a repeating sequential manner until each media item associated with each apparatus is indicated in the apparatus order list.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are diagrams illustrating apparatus communication according to at least one example embodiment;

FIGS. 3A-3D are diagrams illustrating apparatus interaction according to at least one example embodiment;

FIGS. 4A-4F are diagrams illustrating apparatus association according to at least one example embodiment;

FIG. 5 is a flow diagram illustrating activities associated with causing rendering of a rendering media item;

FIG. 6 is a flow diagram illustrating activities associated with causing rendering of a rendering media item;

FIG. 7 is a flow diagram illustrating activities associated with causing rendering of a rendering media item;

FIG. 8 is a flow diagram illustrating activities associated with causing rendering of a rendering media item;

FIG. 9 is a flow diagram illustrating activities associated with causing rendering of a rendering media item;

FIG. 10 is a flow diagram illustrating activities associated with causing rendering of a rendering media item;

FIG. 11 is a flow diagram illustrating activities associated with causing rendering of a rendering media item; and

FIG. 12 is a flow diagram illustrating activities associated with causing rendering of a rendering media item.

### DETAILED DESCRIPTION OF THE DRAWINGS

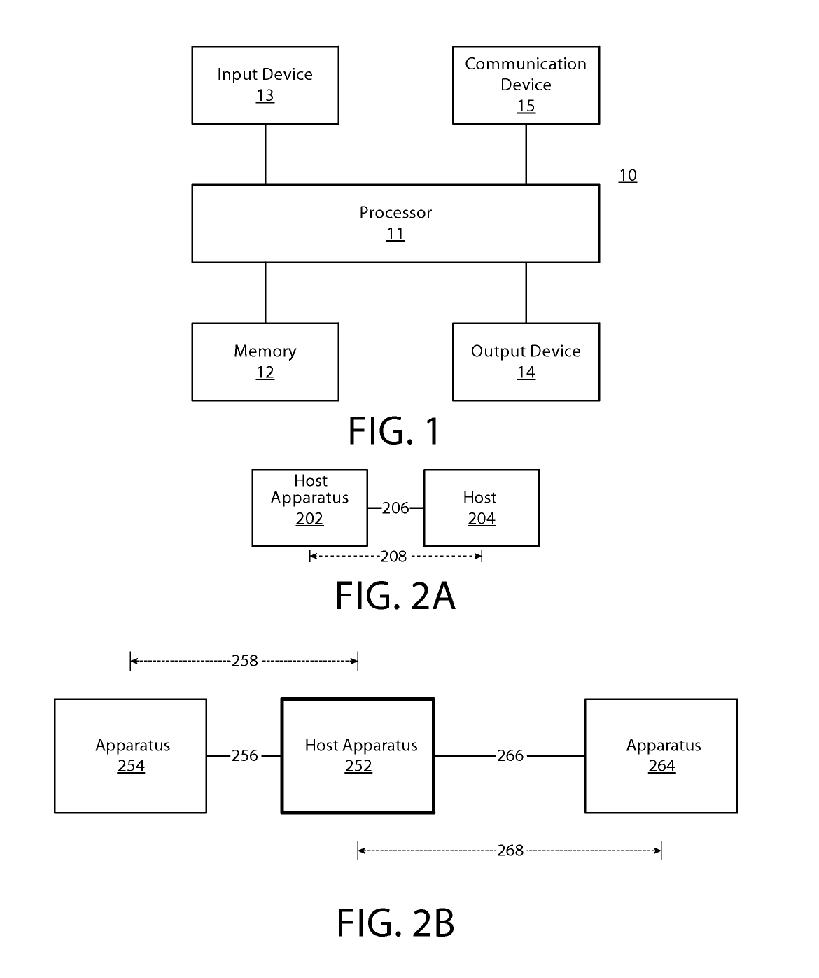

An embodiment of the invention and its potential advantages are understood by referring to FIGS. 1 through 12 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may relate to information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

FIGS. 2A-2B are diagrams illustrating apparatus communication according to at least one example embodiment. The examples of FIGS. 2A-2B are merely examples and do not limit the scope of the claims. For example, apparatus count may vary, communication channels and/or paths may vary, proximity may vary, and/or the like.

In some circumstances, a user may desire to consume media via an electronic apparatus. For example, a user may desire to listen to a song, view an image, watch a video, and/or the like. In some circumstances, a user may desire to share his or her media, consume media associated with other users' electronic apparatuses, and/or the like. For example, a user may desire to allow others to listen to a song associated with the user's apparatus, listen to another song associated with another user's apparatus, listen to a different song associated with a different user's apparatus, view an image associated with yet another user's apparatus, and/or the like. It may be desirable to allow media consumption from multiple electronic apparatuses in a way that allows a user to effect selection of content that is consumed from the user's electronic apparatus in order to, for example, enhance user experience associated with collaboratively consuming and/or sharing of media.

In some circumstances, such as in a group setting, it may be desirable to play media, such as music, images, and/or video, which multiple members of the group enjoy. For example, an electronic apparatus may play music from one or more playlists that are stored on or otherwise associated with the electronic apparatus. In some circumstances, certain members of the group, or users, may prefer certain types of media. For example, one user may prefer rock music, another user may prefer classical music, and/or a different member may prefer folk music. Thus, in some circumstances, it may be desirable to allow electronic apparatuses within a defined geographic proximity to influence, modify, and/or otherwise affect the consumption of media within the group. In at least one example embodiment, an apparatus determines that a first separate apparatus is proximate to the apparatus. For example, the apparatus may determine that the separate apparatus is sufficiently proximate to the apparatus that the separate apparatus is determined to be a member of a group of users consuming media associated with the apparatus and/or the separate apparatus. In some circumstances, an apparatus may be proximate to two separate apparatuses. In such circumstances, the apparatus may determine that a first separate apparatus and a second separate apparatus are proximate to the apparatus. Such a determination of proximity may be based, at least in part, on localization data. In at least one example embodiment, localization data is determined by way of audio localization methods, global positioning system localization methods, network assisted localization methods, near field communication localization methods, and/or the like.

In some circumstances, it may be desirable to restrict determinations of proximity to separate apparatuses within a predefined maximum radius. For example, an apparatus may determine that a first separate apparatus located approximately fifteen centimeters away from the apparatus is proximate to the apparatus, and determine that a second separate apparatus located approximately ten meters away from the apparatus is non-proximate to the apparatus. In at least one example embodiment, determination that a separate apparatus is proximate to an apparatus comprises determination that a distance from the apparatus to the separate apparatus satisfies an apparatus proximity threshold. The apparatus proximity threshold may, for example, relate to a distance within which the apparatus determines a separate apparatus to be proximate. For example, separate apparatuses within a fifty centimeter radius of an apparatus may be determined to be proximate to the apparatus.

In some circumstances, it may be desirable to designate an apparatus as a host apparatus. The host apparatus may, for example, relate to a primary apparatus, a controller apparatus, and/or the like. A proximity-related distance may, for example, relate to a distance between a host apparatus and a first separate apparatus, the host apparatus and a second separate apparatus, the host apparatus and a third separate apparatus, and/or the like. In at least one example embodiment, the apparatus relates to a host apparatus.

In order to effect shared consumption of media, a user may desire an electronic apparatus designated as a host apparatus to coordinate, control, etc. aggregating of media associated with one or more separate apparatuses. For example, the apparatus may receive media from one or more separate apparatuses, may receive a reference associated with media from one or more separate apparatuses, and/or the like. In at least one example embodiment, an apparatus receives information indicative of a media item candidate from a separate apparatus. A media item candidate may, for example, relate to a song, a video, an image, and/or the like, contributed to a host apparatus. Receipt of information indicative of a media item may, for example, relate to receipt of the media item, receipt of a reference associated with the media item, and/or the like. In at least one example embodiment, a media item may be caused to be associated with a separate apparatus from which the media item was received. For example, a media item candidate received from a separate apparatus may be associated with the separate apparatus. Such an association may, for example, relate to establishment of an association between the media item candidate and a separate apparatus identifier that identifies the separate apparatus. The separate apparatus identifier may, for example, relate to an identification number, an international mobile equipment identity number, and/or the like. Such an association may be caused to be established by way of storage of the association in at least one memory, representation of the associated in a data structure, inclusion of the association in metadata, and/or the like. In some circumstances, an apparatus may receive information indicative of a first media item candidate from a first separate apparatus and a second media item candidate from a second separate apparatus. In at least one example embodiments, an apparatus receives information indicative of the second media item candidate from the second separate apparatus. In such an example, the second media item may be associated with the second separate apparatus.

In some circumstances, it may be desirable for a host apparatus to communicate with one or more separate apparatuses associated with the host apparatus. For example, a user may desire a host apparatus to communicate information associated with a separate apparatus, a media item, and/or the like, to one or more separate apparatuses. In at least one example embodiment, an apparatus causes sending of information to one or more separate apparatuses.

FIG. 2A is a diagram illustrating apparatus communication according to at least one example embodiment. In the example of FIG. 2A, host apparatus 202 is in communication with apparatus 204 via communication channel 206. Apparatus 204 relates to a separate apparatus. Communication channel 206 may, for example, relate to a near field communication channel, a wireless communication channel, a cellular communication channel, a Bluetooth communication channel, and/or the like. In the example of FIG. 2A, host apparatus 202 and apparatus 204 are separated by distance 208. A determination regarding whether apparatus 204 is proximate to host apparatus 202 may, for example, be based, at least in part, on distance 208. In the example of FIG. 2A, distance 208 may relate to a distance falling within an apparatus proximity threshold such that apparatus 204 is determined to be proximate to host apparatus 202. In the example of FIG. 2A, host apparatus 202 may receive information indicative of a media item candidate from apparatus 204 by way of communication channel 206, may cause communication of information to apparatus 204 by way of communication channel 206, and/or the like.

FIG. 2B is a diagram illustrating apparatus communication according to at least one example embodiment. In the example of FIG. 2B, host apparatus 252 is in communication with apparatus 254 via communication channel 256. Host apparatus 252 is in communication with apparatus 264 via communication channel 266. In the example of FIG. 2B, apparatus 254 and apparatus 264 may be in direct communication, may communicate via host apparatus 252 by way of communication channels 256 and 266, and/or the like. Each of apparatuses 254 and 264 relate to a separate apparatus. Each of communication channels 256 and 266 may, for example, relate to a near field communication channel, a wireless communication channel, a cellular communication channel, a Bluetooth communication channel, and/or the like. In the example of FIG. 2B, host apparatus 252 and apparatus 254 are separated by distance 258. A determination regarding whether apparatus 254 is proximate to host apparatus 252 may, for example, be based, at least in part, on distance 258. In the example of FIG. 2B, distance 258 may relate to a distance falling within an apparatus proximity threshold such that apparatus 254 is determined to be proximate to host apparatus 252. In the example of FIG. 2B, host apparatus 252 and apparatus 264 are separated by distance 268. A determination regarding whether apparatus 264 is proximate to host apparatus 252 may, for example, be based, at least in part, on distance 268. In the example of FIG. 2B, distance 268 may relate to a distance falling outside of an apparatus proximity threshold such that apparatus 264 is determined to be non-proximate to host apparatus 252. In the example of FIG. 2B, host apparatus 252 may receive information indicative of a media item candidate from apparatus 254 by way of communication channel 256, may cause communication of information to apparatus 254 by way of communication channel 256, and/or the like, based, at least in part, on a determination that apparatus 254 is proximate to host apparatus 252. In the example of FIG. 2B, host apparatus 252 may preclude receipt of information indicative of a media item candidate from apparatus 264, may preclude communication of information to apparatus 264, and/or the like, based, at least in part, on a determination that apparatus 264 is non-proximate to host apparatus 252.

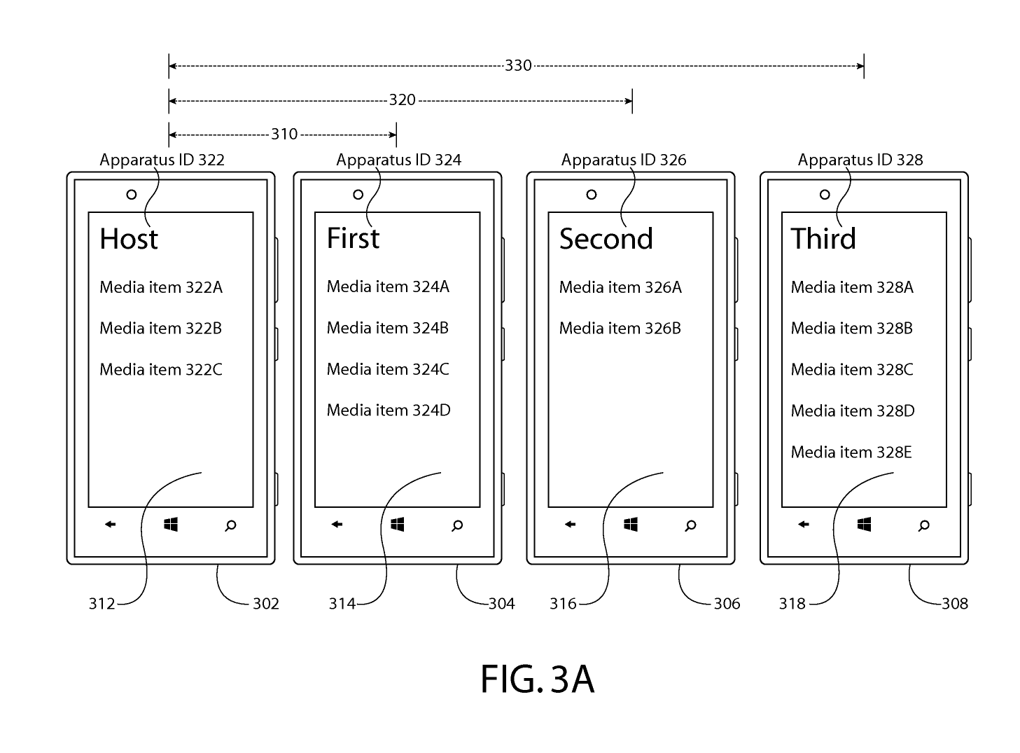

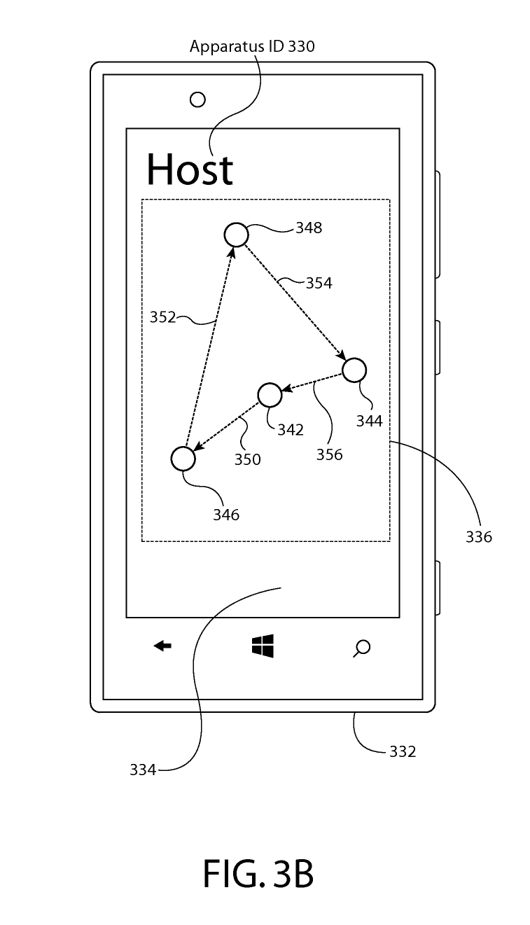

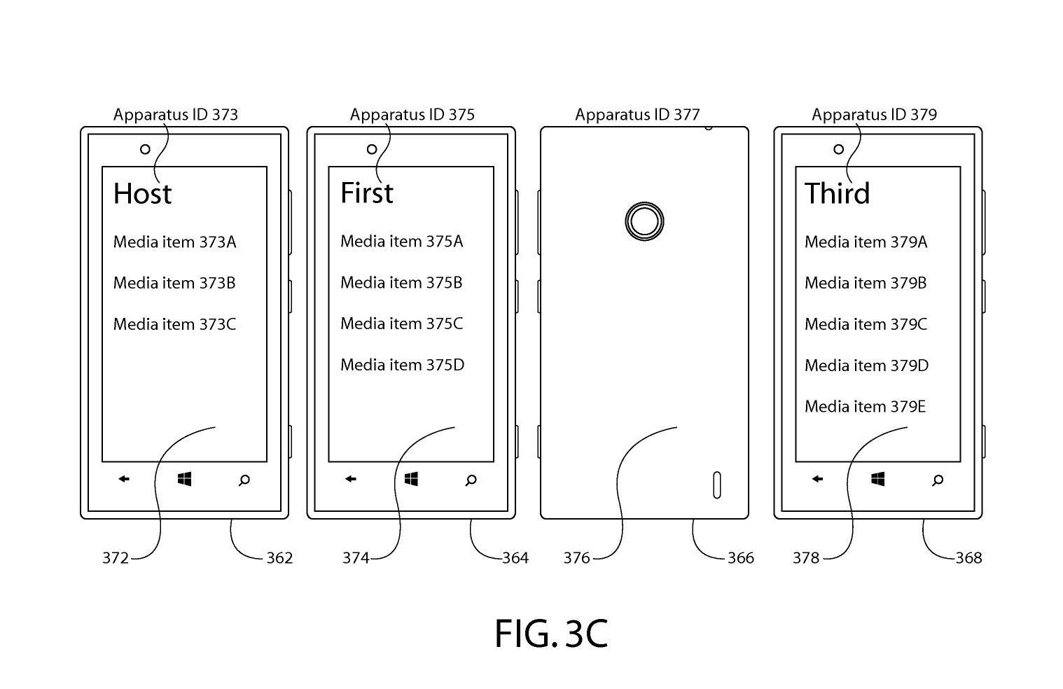

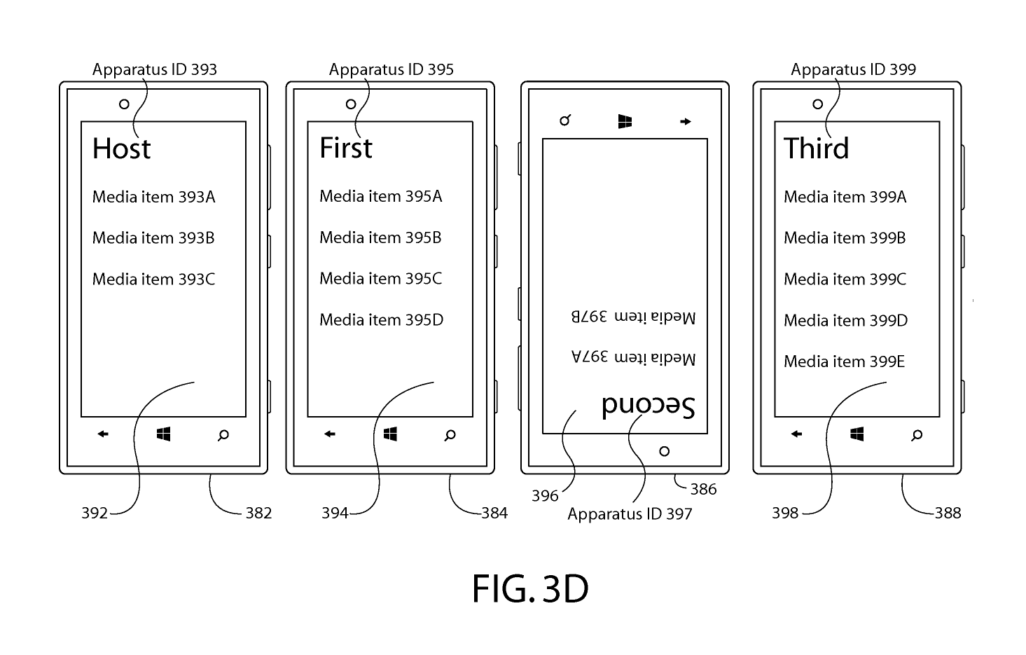

FIGS. 3A-3D are diagrams illustrating apparatus interaction according to at least one example embodiment. The examples of FIGS. 3A-3D are merely examples and do not limit the scope of the claims. For example, apparatus identifiers may vary, media item count and/or association, may vary, apparatus configuration and/or arrangement may vary, and/or the like.

FIG. 3A is a diagram illustrating apparatus interaction according to at least one example embodiment. In the example of FIG. 3A, apparatus 302 relates to a host apparatus comprising touch display 312, and apparatuses 304, 306, and 308 each relate to a separate apparatus comprising touch displays 314, 316, and 318, respectively. In the example of FIG. 3A, apparatus 302, 304, 306, and 308 are associated with apparatus identifiers 322, 324, 326, and 328, respectively. Although apparatus identifiers 322, 324, 326, and 328 are displayed on the display of the respective apparatus, in at least one example embodiment, apparatus identifiers are precluded from display on the display of the respective apparatus. In the example of FIG. 3A, apparatus identifier 322 relates to “Host,” apparatus identifier 324 relates to “First,” apparatus identifier 326 relates to “Second,” and apparatus identifier 328 relates to “Third.” In the example of FIG. 3A, apparatus 302, identified by apparatus identifier 322, is associated with media items 322A, 322B, and 322C. Apparatus 304, identified by apparatus identifier 324, is associated with media items 324A, 324B, 324C, and 324D. Apparatus 306, identified by apparatus identifier 326, is associated with media items 326A and 326B. Apparatus 308, identified by apparatus identifier 328, is associated with media items 328A, 328B, 328C, 328D, and 328E. In the example of FIG. 3A, apparatus 302 and apparatus 304 are separate by distance 310, apparatus 302 and apparatus 306 are separated by distance 320, and apparatus 302 and apparatus 308 are separated by distance 330. In the example of FIG. 3A, each of apparatuses 304, 306, and 308 may related to apparatuses determined to be proximate to apparatus 302 based, at least in part, on distances 310, 320, and 330, respectively.

In some circumstances, it may be desirable to render one or more received media item candidates. For example, in order to facilitate shared consumption of media in a group setting, it may be desirable to receive one or more media item candidates, or suggested media items, from one or more separate apparatuses. Once received by the apparatus, it may be desirable to cause rendering of a selected one of the received media items. For example, the apparatus may be in communication with a speaker, a display, a projector, and/or the like, such that the apparatus may cause rendering of a media item for shared consumption in the group setting. In at least one example embodiment, an apparatus determines a rendering media item based, at least in part, on a first media item candidate and a second media item candidate. For example, if the apparatus receives a first media item candidate from a first separate apparatus and a second media item candidate from a second separate apparatus, the apparatus may determine to designate one of the received media item candidates as the rendering media item. In at least one example embodiment, a rendering media item relates to a media item candidate for rendering by the apparatus, for rendering by another apparatus, and/or the like.

In some circumstances, it may be desirable to cause rendering of a media item candidate based, at least in part, on a separate apparatus associated with the media item candidate. For example, it may be desirable to add a layer of interactivity to a shared media consumption environment such that determination of a media item candidate for rendering is based, at least in part, on a proximity between an apparatus and the separate apparatus associated with the media item candidate. For example, an apparatus may cause rendering of a media item candidate associated with a separate apparatus which is positioned closer to the apparatus than another separate apparatus, which is positioned closer to the apparatus than any other separate apparatus, and/or the like. In at least one example embodiment, determination of a rendering media item comprises determination that the rendering media item relates to the first media item candidate based, at least in part, on the association between the first media item candidate and the first separate apparatus. In at least one example embodiment, determination that a rendering media item relates to a media item candidate may be further based, at least in part, on a first distance indicative of a distance between a separate apparatus and the apparatus. Determination that the rendering media item relates to the first media item candidate may, for example, be further based, at least in part, on the first distance being less than a second distance that is indicative of a distance between the second separate apparatus and the apparatus. For example, in the configuration illustrated in FIG. 3A, determination that a rendering media item relates to media item 324A may be based, at least in part, on distance 310 being less than distance 320, distance 310 being less than distance 330, and/or the like.

In some circumstances, a user may desire to be notified when a media item candidate associated with the user's separate apparatus is designated as a rendering media item. For example, a user may desire notification when a song stored on the user's electronic apparatus is selected for rendering. In at least one example embodiment, an apparatus causes communication of a notification to a separate apparatus based, at least in part, on a determination that a rendering media item relates to a media item candidate and an association between the media item candidate and the separate apparatus.

In at least one example embodiment, an apparatus causes rendering of the rendering media item. Rendering of the rendering media item may, for example, relate to rendering the rendering media item by the apparatus, streaming the rendering media item to another apparatus, sending a playlist to another apparatus, and/or the like. The other apparatus may, for example, relate to a computer, a speaker, a display, a projector, a separate apparatus, and/or the like. In at least one example embodiment, rendering of a media item candidate may relate to determining that the media item candidate relates to a rendering media item, and causing rendering of the rendering media item. For example, a media item candidate may be determined to be a rendering media item and subsequently caused to be rendered.

In order to facilitate an interactive group media consumption environment, it may be desirable to repeatedly determine proximity between an apparatus and one or more apparatuses. For example, in some circumstances, it may be desirable to cause rendering of a first media item candidate associated with a first separate apparatus and preclude rendering of a second media item candidate associated with a second separate apparatus based, at least in part, on the first separate apparatus being positions closer to the apparatus than the second separate apparatus. In such an example, if the second separate apparatus is repositioned to be closer to the apparatus than the first separate apparatus, it may be desirable to cause rendering of the second media item candidate. In at least one example embodiment, an apparatus determines that a second distance has become less than a first distance. The second distance may, for example, relate to a distance between the second separate apparatus and the apparatus in the previous example. The first distance may, for example, relate to a distance between the first separate apparatus and the apparatus in the previous example. In at least one example embodiment, an apparatus determines that a rendering media item relates to a media item candidate associated with the second apparatus based, at least in part, on an association between the media item candidate and the second separate apparatus, and the second distance being less than the first distance. For example, apparatus 302 may cause rendering of media item 324A based, at least in part, on apparatus 304 being positioned closer to apparatus 302 than either of apparatus 306 or 308. If, for example, apparatus 306 switches places with apparatus 304, apparatus 302 may cause rendering of media item 326A based, at least in part, on apparatus 306 being positioned closer to apparatus 302 than either of apparatus 304 or 308.

In some circumstances, it may be desirable to cause rendering of more than one media item candidate. For example, a user may desire to consume more than one media item candidates associated with more than one separate apparatus. In at least one example embodiment, subsequent to determination and rendering or a first rendering media item, an apparatus may determine a second rendering media item to relate to the second media item candidate based, at least in part, on the rendering media item and the association between the second media item candidate and the second separate apparatus. For example, after causing rendering of a first media item associated with a first separate apparatus, the apparatus may cause rendering of a second media item associated with a second separate apparatus, the first separate apparatus, and/or the like. In order to provide for an intuitive media rendering environment, it may be desirable to wait until rendering of a first rendering media item has completed before rendering of a second rendering media item. For example, it may be desirable to complete playback of a song, playback of a video, display of an image, and/or the like, prior to rendering another media item. In at least one example embodiment, an apparatus determines that rendering of the rendering media item has completed.

In some circumstances, it may be desirable to determine a rendering media item based on media item candidates associated with the apparatus in addition to media item candidates associated with one or more separate apparatuses. For example, the apparatus may be associated with songs, images, and/or videos, and the user of the apparatus may desire to cause rendering of such media along with media associated with one or more separate apparatuses. In at least one example embodiment, an apparatus determines a host media item candidate. A host media item candidate may, for example, relate to a media item candidate associated with the apparatus, a host apparatus, and/or the like. Similarly, a non-host media item candidate may, for example, relate to a media item candidate associated with a separate apparatus, a non-host apparatus, and/or the like. Thus, in at least one example embodiment, a determination of a rendering media item is based, at least in part, on a first host media candidate. In at least one example embodiment, an apparatus causes rendering of a first host media item candidate.

In some circumstances, it may be desirable to selectively render media item candidates associated with a separate apparatus, to selectively render media item candidates associated with a host apparatus, to alternately render media items candidates associated with a separate apparatus and a host apparatus, and/or the like. For example, a user may have a party playlist configured on the user's electronic apparatus. The user may, for example, desire to allow for group contribution to the party playlist. In such an example, the user may further desire to limit such contribution to specific times within playback of the party playlist. Such a limitation may, for example, relate to a host rendering break point, a non-host rendering break point, and/or the like.

In at least one example embodiment, an apparatus determines that a host rendering break point has been satisfied. In such an example embodiment, determination of a rendering media item may be based, at least in part, on a determination that a host rendering break point has been satisfied. For example, an apparatus may cause rendering of media item candidates associated with the apparatus until, for example, a host rendering break point has been satisfied. A host rendering break point may, for example, relate to a point at which an apparatus switches from causing rendering of media item candidates associated with the apparatus to causing rendering of media item candidates associated with at least one separate apparatus. For example, an apparatus may switch from rendering host media item candidates to rendering non-host media item candidates based, at least in part, on a host rendering break point. The host rendering breakpoint may, for example, relate to a criteria that designates a condition to be satisfied for the apparatus to cause rendering of a non-host media item candidate. The non-host media item candidate may, for example, relate to a media item candidate received from a separate apparatus. In at least one example embodiment, a host rendering break point relates to a number of host media item candidates to be rendered prior to causation of rendering of a non-host media item candidate. For example, an apparatus may cause rendering of ten host media item candidates prior to causing rendering of a non-host media item candidate, may alternate causing rendering of a host media item candidate and causing rendering of a non-host media item candidate, and/or the like. In one or more example embodiment, a host rendering break point relates to a duration for rendering host media item candidates prior to causation of rendering of a non-host media item candidate. For example, an apparatus may cause rendering of host media item candidates for ten minutes prior to causing rendering of a non-host media item candidate, may cause rendering of five host media item candidates prior to causing rendering of a non-host media item candidate, may alternate causing rendering of host media item candidates for five minutes and causing rendering of non-host media item candidates for five minutes, may alternate causing rendering of three host media item candidates and causing rendering of two non-host media item candidates, and/or the like.

In at least one example embodiment, an apparatus determines that a non-host rendering break point has been satisfied. In such an example embodiment, determination of a rendering media item may be based, at least in part, on a determination that a non-host rendering break point has been satisfied. For example, an apparatus may cause rendering of media item candidates associated with at least one separate apparatus until, for example, a non-host rendering break point has been satisfied. A non-host rendering break point may, for example, relate to a point at which an apparatus switches from causing rendering of media item candidates associated with at least one separate apparatus to causing rendering of media item candidates associated with the apparatus. For example, an apparatus may switch from rendering non-host media item candidates to rendering host media item candidates based, at least in part, on a non-host rendering break point. The non-host rendering breakpoint may, for example, relate to a criteria that designates a condition to be satisfied for the apparatus to cause rendering of a host media item candidate. In at least one example embodiment, a non-host rendering break point relates to a number of non-host media item candidates to be rendered prior to causation of rendering of a host media item candidate. For example, an apparatus may cause rendering of ten non-host media item candidates prior to causing rendering of a host media item candidate, may alternate causing rendering of a non-host media item candidate and causing rendering of a host media item candidate, and/or the like. In one or more example embodiment, a non-host rendering break point relates to a duration for rendering non-host media item candidates prior to causation of rendering of a host media item candidate. For example, an apparatus may cause rendering of non-host media item candidates for ten minutes prior to causing rendering of a host media item candidate, may cause rendering of five non-host media item candidates prior to causing rendering of a host media item candidate, may alternate causing rendering of non-host media item candidates for five minutes and causing rendering of host media item candidates for five minutes, may alternate causing rendering of three non-host media item candidates and causing rendering of two host media item candidates, and/or the like.

In some circumstances, a user may desire rendering of a rendering media item to complete notwithstanding existence of a host rendering break point, a non-host rendering break point, and/or the like. For example, the user may desire to avoid prematurely cutting off playback of a song, playback of a video, displaying of an image, and/or the like. In at least one example embodiment, termination of rendering of a non-host media item candidate is subsequent to the determination that rendering of the non-host media item candidate has completed. Similarly, in at least one example embodiment, termination of rendering of a host media item candidate is subsequent to the determination that rendering of the host media item candidate has completed.

In some circumstances, a user may desire to selectively filter rendering of a media item candidate, to selectively allow rendering of a media item, to selectively preclude rendering of a media item candidate, and/or the like. For example, a user may enjoy listening to classical music, but may deplore listening to rock music. In such an example, the user may configure the user's electronic apparatus to cause filtering of media item candidates based, at least in part, on the user's preferences. In at least one example embodiment, an apparatus determines at least one media item selection criteria. The media item selection criteria may, for example, relate to designation of a constraint on selection of a media item candidate based, at least in part, on metadata associated with the media item candidate. Metadata associated with an audio media item candidate may, for example, relate to a genre, a duration, a tempo, an artist, a composer, a production year, a lyrical content, a band origin, and/or the like. Metadata associated with an image media item candidate may, for example, relate to shading data, histogram data, subject matter data, location and orientation data, chronological data, a photographer, and/or the like. Metadata associated with a video media item candidate may, for example, relate to a duration, a genre, a producer, an actor, location and orientation data, chronological data, and/or the like. In at least one example embodiment, determination of the rendering media item may be based, at least in part, on the media item selection criteria.

In some circumstances, a user may desire to filter media item candidates at one or more separate apparatuses. For example, an apparatus may cause communication of at least one filtering criteria to the one or more separate apparatuses such that the separate apparatuses are caused to allow selection of a media item candidates satisfying the filtering criteria. In at least one example embodiment, an apparatus sends information indicative of a media item selection criteria to a first separate apparatus and a second separate apparatus. In such an example embodiment, a first media item candidate received from the first separate apparatus and a second media item candidate received from the second separate apparatus satisfy the media item selection criteria. The sending of information indicative of the media item selection criteria to the first separate apparatus may, for example, cause the first separate apparatus to constrain the first media item candidate to a media item candidate that satisfies the media item selection criteria. In some circumstances, a user may desire the shared consumption of media to be based upon similar filtering constraints received from separate apparatuses associated with the user's apparatus. For example, if a user associated with a separate apparatus dislikes folk music, such an indication may be communicated to and received by the apparatus. In at least one example embodiment, an apparatus receives information indicative of a media item selection criteria designation. The information indicative of a media item selection criteria designation may, for example, relate to information received from one or more input devices. Such media item selection criteria may relate to limiting a genre of music, limiting a subject matter of images, and/or the like. The information indicative of a media item selection criteria designation may, for example, relate to information received from at least one separate apparatus.

In some circumstances, it may be desirable to cause rendering of media item candidates associated with an apparatus and each associated separate apparatus. For example, in order to promote an interactive group media consumption environment, a user may desire to cause rendering of media item candidates associated with every participating apparatus and/or separate apparatus. In at least one example embodiment, an apparatus determines an apparatus order list that is indicative of an apparatus sequence. For example, the apparatus may be associated with a first separate apparatus comprising a first media item candidate and a second separate apparatus comprising a second media item candidate. In such an example, determination of a first rendering media item may be based, at least in part, on the apparatus sequence correlating with a first separate apparatus. Further, determination of a second rendering media item may be based, at least in part, on the apparatus sequence correlating with the second separate apparatus. In at least one example embodiment, an apparatus order list relates to a list that indicates a sequence of media items to be rendered based, at least in part, on correlation of the media items to an apparatus designated by the apparatus order list. The apparatus order list may, for example, relate to indication of a predetermined number of media items associated with an apparatus associated with the media items in a repeating sequential manner until each media item associated with each apparatus is indicated in the apparatus order list. For example, the apparatus order list may indicate rendering of two media item candidates associated with a first separate apparatus, followed by rendering of two media item candidates associated with a second separate apparatus. In another example, the apparatus order list may indicate rendering of a host media item, subsequent to rendering of a non-host media item candidate associated with a first separate apparatus, subsequent to rendering of a non-host media item candidate associated with a second separate apparatus, and/or the like.

In at least one example embodiment, determination of an apparatus order list may be based, at least in part, on a ranking of distance between the apparatus and a separate apparatus represented in the apparatus order list. For example, in at least one example embodiment, an apparatus order list comprises an indication of a second separate apparatus subsequent to a first separate apparatus based, at least in part, on a distance from the apparatus to the first separate apparatus being less than a distance from the apparatus to the second separate apparatus. Similarly, in at least one example embodiment, an apparatus order list comprises an indication of a third separate apparatus subsequent to the second separate apparatus based, at least in part, on a distance from a first separate apparatus to a second separate apparatus being less than a distance from the first separate apparatus to the third separate apparatus. Arrangement of an apparatus and one or more separate apparatuses may relate to a linear arrangement, a stacked arrangement, a scattered arrangement, and/or the like. For example, one or more separate apparatuses may be stacked on top of the apparatus, the apparatus may be stacked between two or more separate apparatuses, the apparatus may be surrounded by a rough circle of separate apparatuses, the apparatus may be in a line comprised by one or more separate apparatus, and/or the like.

In some circumstances, a user may desire selection of separate apparatuses to correlate with a physical arrangement of the apparatuses in relation to an apparatus. For example, a user may desire to render a media item candidate associated with a separate apparatus positioned to the left of the apparatus, to the right of the apparatus, above the apparatus, below the apparatus, on top of the apparatus, under the apparatus, and/or the like. In at least one example embodiment, indication of a second separate apparatus subsequent to a first separate apparatus may be based, at least in part, on the first separate apparatus and the second separate apparatus being in a predetermined direction from the apparatus. For example, apparatus 304 is directly to the right of apparatus 302. Based, at least in part, on the position of apparatus 304 being in a predetermined direction from apparatus 302, a media item candidate associated with apparatus 304 may, for example, be caused to be rendered prior to a media item candidate associated with apparatus 306. In such an example, based, at least in part, on apparatus 306 being positioned to the right of apparatus 304, upon completion of rendering the media item candidate associated with apparatus 304, apparatus 302 may cause rendering of a media item associated with apparatus 306.

In some circumstances, it may be desirable to base rendering on a predetermined order. For example, a user may desire to predetermine an order of media item candidate rendering, an order of separate apparatus selection, and/or the like. In at least one example embodiment, determination of apparatus order list may be based, at least in part, on a predetermined apparatus order. The predetermined apparatus order may, for example, relate to an apparatus order list having predetermined ordering of apparatuses for purposes of rendering media item selection. In at least one example embodiment, an apparatus may receive information indicative of a predetermined apparatus order. Such receipt may be from, for example, a separate apparatus, a server, a computer, a phone, a tablet, and/or the like. In at least one example embodiment, information indicative of a predetermined apparatus order relates to one or more inputs. Such inputs may, for example, be received by one or more input devices associated with the apparatus. In at least one example embodiment, predetermined apparatus order is received from at least one of memory, a repository, or a separate apparatus.

FIG. 3B is a diagram illustrating apparatus interaction according to at least one example embodiment. In the example of FIG. 3B, apparatus 332 relates to a host apparatus. Apparatus 332 comprises touch display 334 and is associated with apparatus identifier 330, which relates to “Host.” In the example of FIG. 3B, apparatus 332 causes display of geographical region 336 on touch display 334. Geographical region 336 relates to a representation of a spatial region surrounding apparatus 332, which includes all separate apparatuses associated with apparatus 332, for example, all separate apparatuses within an apparatus proximity threshold associated with apparatus 332. In the example of FIG. 3B, apparatus representation 342 relates to a representation associated with apparatus 332. In the example of FIG. 3B, separate apparatus representations 346, 348, and 344 relate to representations associated with separate apparatuses within an apparatus proximity threshold associated with apparatus 332. In at least one example embodiment, apparatus 332 is configured to receive input indicative of a predetermined apparatus order by way of touch display 334.

In some circumstances, a user may desire to set a predetermined apparatus order via the user's apparatus. For example, the apparatus may be configured to receive input indicative of a predetermined apparatus order. In at least one example embodiment, such input relates to visually representing a predetermined apparatus order by way of an input connecting one or more separate apparatus representations to the apparatus in an order that reflects a desired apparatus order. In at least one example embodiment, an apparatus receives indication of an input associated with a separate apparatus to cause a representation of the separate apparatus to be displayed on a display associated with the apparatus. In at least one example embodiment, the received indication indicates a shaking of the separate apparatus. For example, shaking the separate apparatus may communicate information indicative of such input to the apparatus. The apparatus may, for example, be configured to receive such an indication. In at least one example embodiment, an apparatus receives information indicative of a proximate separate apparatus based, at least in part, on the separate apparatus receiving a shaking input. A shaking input may, for example, relate to shaking of the separate apparatus, oscillating of the separate apparatus, swinging of the separate apparatus, and/or the like.

In at least one example embodiment, apparatus 332 receives input indicative of a predetermined apparatus order by way of touch display 334. For example, apparatus 332 may receive one or more inputs associated with connecting apparatus representation 342, separate apparatus representation 344, separate apparatus representation 346, and separate apparatus representation 348, wherein the order and/or arrangement of inputs and/or connections indicates the predetermined apparatus order. For example, apparatus 332 may receive information indicative of input 350 connecting apparatus representation 342 to separate apparatus representation 346, subsequent to receiving information indicative of input 352 connecting separate apparatus representation 346 to separate apparatus representation 348, and subsequent to receiving information indicative of input 354 connecting separate apparatus representation 348 to separate apparatus representation 344. In such an example, the predetermined apparatus order may relate to an order in which apparatus 332 is subsequent to a separate apparatus represented by separate apparatus representation 346, subsequent to a separate apparatus represented by separate apparatus representation 348, and subsequent to a separate apparatus represented by separate apparatus representation 344. In at least one example embodiment, apparatus 332 may receive information indicative of input 356 connecting separate apparatus representation 344 to apparatus representation 342. Such an input may, for example, indicate completion of setting a predetermined apparatus order, indicate looping through the predetermined apparatus order, and/or the like.

FIG. 3C is a diagram illustrating apparatus interaction according to at least one example embodiment. In the example of FIG. 3C, apparatus 362 relates to a host apparatus comprising touch display 372, and apparatuses 364 and 368 each relate to a separate apparatus comprising touch displays 374 and 378, respectively. Apparatus 366 comprising back shell 376. In the example of FIG. 3C, apparatus 366 is oriented such that back shell 376 faces away from a surface upon which apparatuses 362, 364, 366, and 368 rest, while apparatuses 362, 364, and 368 are oriented such that touch displays 372, 374, and 378, respectively, face away from the surface. In at least one example embodiment, the orientation of apparatus 366 relates to a flipped over orientation, a face down orientation, a display down orientation, and/or the like. In the example of FIG. 3C, apparatus 362, 364, 366, and 368 are associated with apparatus identifiers 373, 375, 377, and 379, respectively. Although apparatus identifiers 373, 375, and 379 are displayed on the display of the respective apparatus, in at least one example embodiment, apparatus identifiers are precluded from display on the display of the respective apparatus. In the example of FIG. 3C, apparatus identifier 373 relates to “Host,” apparatus identifier 375 relates to “First,” apparatus identifier 377 relates to “Second,” and apparatus identifier 379 relates to “Third.” In the example of FIG. 3C, apparatus 362, identified by apparatus identifier 373, is associated with media items 373A, 373B, and 373C. Apparatus 364, identified by apparatus identifier 375, is associated with media items 375A, 375B, 375C, and 375D. Apparatus 366, identified by apparatus identifier 377, is associated with at least one media item candidate. Apparatus 368, identified by apparatus identifier 379, is associated with media items 379A, 379B, 379C, 379D, and 379E. In the example of FIG. 3C, each of apparatuses 364, 366, and 368 may related to apparatuses determined to be proximate to apparatus 362.

In some circumstances, it may be desirable to allow for modification to an apparatus order list. For example, a user may desire to temporarily preclude rendering of media item candidates associated with the user's apparatus. For example, a user may orient his or her apparatus such that a display associated with the apparatus is facing a surface upon which the apparatus is resting. In at least one example embodiment, an apparatus receives information indicative of a change of an apparatus order list. In at least one example embodiment, the information indicative of the change of the apparatus order list is received from a separate apparatus. The separate apparatus may, for example, determine the change of the apparatus order list based, at least in part, on an input received by the separate apparatus. In at least one example embodiment, an apparatus receives indication of an input relating to a change of an apparatus order list from a separate apparatus. In at least one example embodiment, determination of a different apparatus order list may be based, at least in part, on a change of an apparatus order list. The different apparatus order list may, for example, relate to an order list that is different than a predetermined order list, that is different than an apparatus order list subsequent to receipt of information indicative of a change of an apparatus order list, and/or the like. In at least one example embodiment, determination of a third rendering media item may be based, at least in part, on a different apparatus order list.

In at least one example embodiment, a change of an apparatus order list relates to skipping of a second separate apparatus such that a different apparatus order list comprises an indication of a third separate apparatus subsequent and adjacent to a first separate apparatus. The information indicative of the change of the apparatus order list may, for example, relate to skipping of the third separate apparatus. For example, placing apparatus 366 in a display down orientation may cause preclusion of rendering of a media item candidate associated with apparatus 366. For example, an apparatus order list may indicate rendering of media item 373A, followed by rendering of media item 375A, followed by rendering of a media item candidate associated with apparatus 366, followed by rendering of media item 379A. In such an example, based, at least in part, on orienting apparatus 366 in a display down orientation, apparatus 362 may receive information indicative of a change to an apparatus order list. The resulting different apparatus order list may, for example, indicate rendering of media item 373A, followed by rendering of media item 375A, followed by rendering of media item 379A. Restated, such a change may relate to skipping rendering of the media item candidate associated with the display down apparatus 366.

FIG. 3D is a diagram illustrating apparatus interaction according to at least one example embodiment. In the example of FIG. 3D, apparatus 382 relates to a host apparatus comprising touch display 392, and apparatuses 384, 386, and 388 each relate to a separate apparatus comprising touch displays 394, 396, and 398, respectively. In the example of FIG. 3D, apparatus 386 is oriented such that touch display 396 appears upside down, from a viewer's perspective, in relate to apparatuses 382, 384, and 388, while apparatuses 382, 384, and 388 are oriented such that touch displays 392, 394, and 398, respectively, appear right side up from a viewer's perspective. In at least one example embodiment, the orientation of apparatus 386 relates to an upside down orientation, an inverted orientation, and/or the like. In the example of FIG. 3D, apparatus 382, 384, 386, and 388 are associated with apparatus identifiers 393, 395, 397, and 399, respectively. Although apparatus identifiers 393, 395, 397, and 399 are displayed on the display of the respective apparatus, in at least one example embodiment, apparatus identifiers are precluded from display on the display of the respective apparatus. In the example of FIG. 3D, apparatus identifier 393 relates to “Host,” apparatus identifier 395 relates to “First,” apparatus identifier 397 relates to “Second,” and apparatus identifier 399 relates to “Third.” In the example of FIG. 3D, apparatus 382, identified by apparatus identifier 393, is associated with media items 393A, 393B, and 393C. Apparatus 384, identified by apparatus identifier 395, is associated with media items 395A, 395B, 395C, and 395D. Apparatus 386, identified by apparatus identifier 397, is associated with media items 397A and 397B. Apparatus 388, identified by apparatus identifier 399, is associated with media items 399A, 399B, 399C, 399D, and 399E. In the example of FIG. 3D, each of apparatuses 384, 386, and 388 may related to apparatuses determined to be proximate to apparatus 382.

In at least one example embodiment, a change of an apparatus order list may relate to a reversal of the apparatus order list from a position of the apparatus order list. The information indicative of the change of the apparatus order list may, for example, relate to a reversal from a third separate apparatus such that the different apparatus order list comprises an indication of a first separate apparatus subsequent to a second separate apparatus. For example, placing apparatus 386 in an upside down orientation may cause preclusion of rendering of a media item candidate associated with apparatus 386 and/or a reversal of an associated apparatus order list. For example, an apparatus order list may indicate rendering of media item 393A, followed by rendering of media item 395A, followed by rendering of a media item 397A, followed by rendering of media item 399A. In such an example, media item 393A and 395A may be caused to be rendered. In such an example, based, at least in part, on orienting apparatus 386 in an upside down orientation, apparatus 382 may receive information indicative of a change to an apparatus order list. The resulting different apparatus order list may, for example, indicate rendering of media item 395B, followed by rendering of media item 393B, followed by rendering of media item 399A, followed by rendering of media item 393C, followed by rendering of media item 395C. Restated, such a change may relate to reversal of a rendering direction associated with the apparatus order list upon the apparatus order list indicating a media item associated with apparatus 386 based, at least in part, on the upside down orientation of apparatus 386.

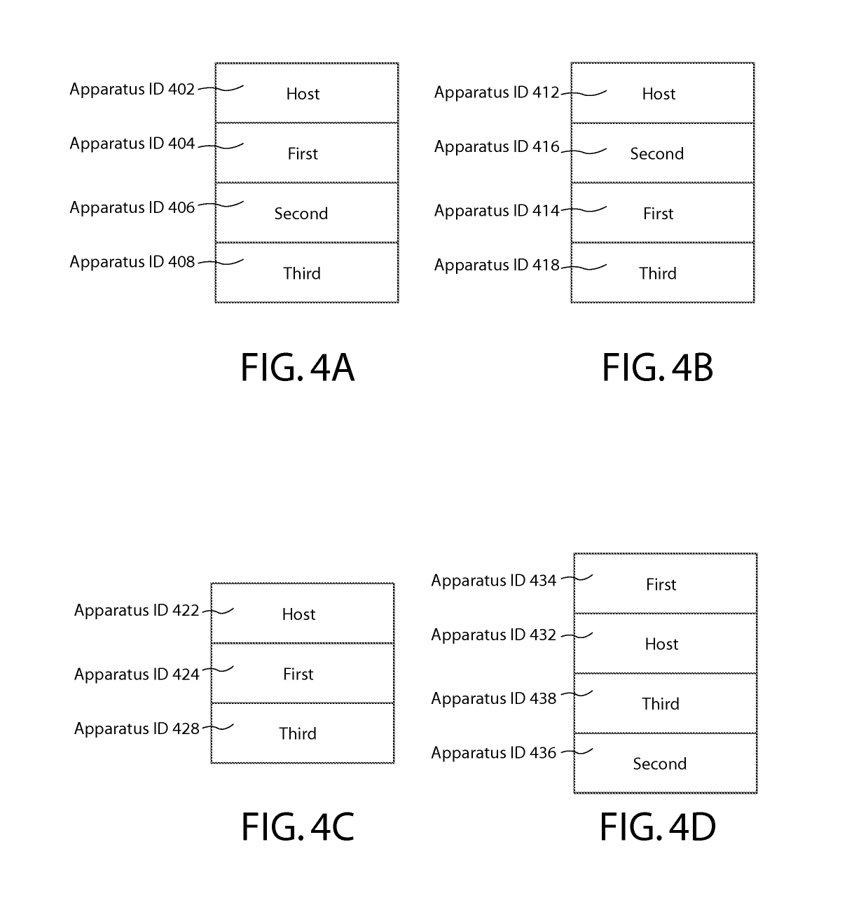

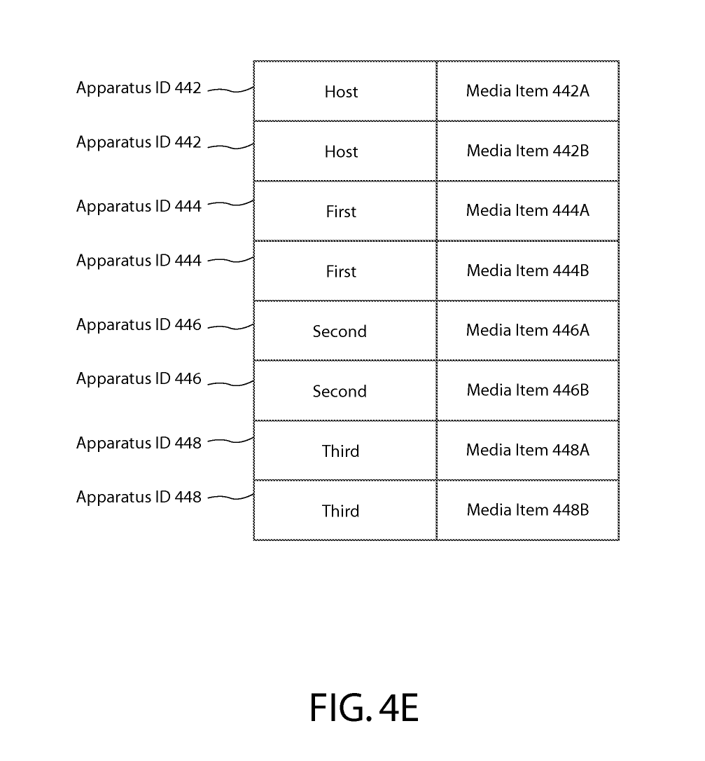

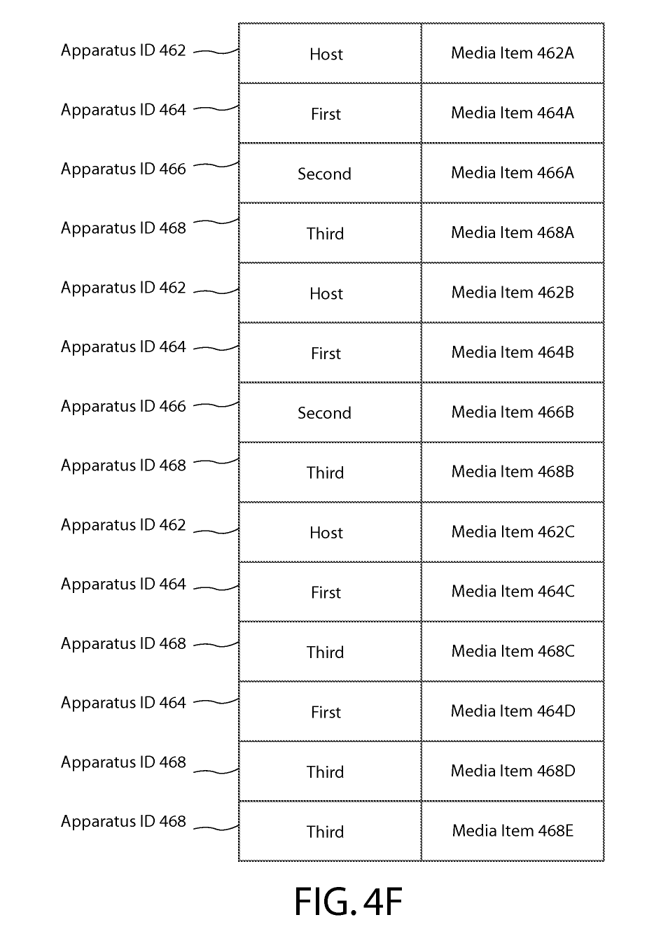

FIGS. 4A-4F are diagrams illustrating apparatus association according to at least one example embodiment. The examples of FIGS. 4A-4F are merely examples and do not limit the scope of the claims. For example, apparatus identifiers may vary, apparatus identifier order may vary, and/or the like.

FIG. 4A is a diagram illustrating apparatus association according to at least one example embodiment. The example of FIG. 4A relates to an apparatus order list comprising apparatus identifiers 402, 404, 406, and 408. In the example of FIG. 4A, apparatus identifier 402 identifies a host apparatus and each of apparatus identifiers 404, 406, and 408 identify a separate apparatus. In the example of FIG. 4A, the apparatus order list may comprise apparatus identifiers 404, 406, and 408 based, at least in part, on a determination that the separate apparatuses identified by apparatus identifiers 404, 406, and 408 each relate to a separate apparatus proximate to an apparatus identified by apparatus identifier 402. In the example of FIG. 4A, the apparatus order list may indicate rendering of a media item associated with apparatus identifier 402, followed by rendering of a media item associated with apparatus identifier 404, followed by rendering of a media item associated with apparatus identifier 406, and followed by rendering of a media item associated with apparatus identifier 408.

FIG. 4B is a diagram illustrating apparatus association according to at least one example embodiment. The example of FIG. 4B relates to a repositioning of a separate apparatus identified by apparatus identifier 406 in FIG. 4A such that the separate apparatus is closer to an apparatus identified by apparatus identifier 402 than the apparatus identified by apparatus identifier 404. As such, the apparatuses identified by apparatus identifiers 402, 404, 406, and 408 in FIG. 4A correlate with the apparatuses identified by apparatus identifiers 412, 414, 416, and 418 in FIG. 4B, respectively. The apparatus order list of FIG. 4B, for example, is based, at least in part, on the relative proximity of identified separate apparatuses to the apparatus identified by apparatus identifier 412.

In the example of FIG. 4B, apparatus identifier 412 identifies a host apparatus and each of apparatus identifiers 414, 416, and 418 identify a separate apparatus. In the example of FIG. 4B, the apparatus order list may comprise apparatus identifiers 414, 416, and 418 based, at least in part, on a determination that the separate apparatuses identified by apparatus identifiers 414, 416, and 418 each relate to a separate apparatus proximate to an apparatus identified by apparatus identifier 412. In the example of FIG. 4B, the apparatus order list may indicate rendering of a media item associated with apparatus identifier 412, followed by rendering of a media item associated with apparatus identifier 416, followed by rendering of a media item associated with apparatus identifier 414, and followed by rendering of a media item associated with apparatus identifier 418.

FIG. 4C is a diagram illustrating apparatus association according to at least one example embodiment. The example of FIG. 4C relates to an apparatus order list based, at least in part, on receipt of a change of an apparatus order list associated with skipping of a separate apparatus associated with apparatus identifier 406 of FIG. 4A. As such, the apparatuses identified by apparatus identifiers 402, 404, and 408 in FIG. 4A correlate with the apparatuses identified by apparatus identifiers 422, 424, and 428 in FIG. 4C, respectively. The apparatus identified by apparatus identifier 406 in FIG. 4A fails to correlate with an apparatus in FIG. 4C based, at least in part, on skipping of that apparatus. The example of FIG. 4C may relate to an apparatus order list associated with the configuration illustrated in FIG. 3C.

In the example of FIG. 4C, apparatus identifier 422 identifies a host apparatus and each of apparatus identifiers 424 and 428 identify a separate apparatus. In the example of FIG. 4C, the apparatus order list may comprise apparatus identifiers 424 and 428 based, at least in part, on a determination that the separate apparatuses identified by apparatus identifiers 424 and 428 each relate to a separate apparatus proximate to an apparatus identified by apparatus identifier 422. The apparatus order list may preclude information indicative of apparatus identifier 406 of FIG. 4A based, at least in part, on receipt of an input indicative of skipping a separate apparatus identified by apparatus identifier 406 of FIG. 4A. In the example of FIG. 4C, the apparatus order list may indicate rendering of a media item associated with apparatus identifier 422, followed by rendering of a media item associated with apparatus identifier 424, and followed by rendering of a media item associated with apparatus identifier 428. In the example of FIG. 4C, the apparatus order list may preclude rendering of a media item associated with apparatus identifier 406 of FIG. 4A based, at least in part, on receipt of an input indicative of skipping a separate apparatus identified by apparatus identifier 406 of FIG. 4A.

FIG. 4D is a diagram illustrating apparatus association according to at least one example embodiment. The example of FIG. 4D relates to an apparatus order list based, at least in part, on receipt of a change of an apparatus order list associated with reversal of order at a separate apparatus associated with apparatus identifier 406 of FIG. 4A. As such, the apparatuses identified by apparatus identifiers 402, 404, 406, and 408 in FIG. 4A correlate with the apparatuses identified by apparatus identifiers 432, 434, 436, and 438 in FIG. 4D, respectively. The example of FIG. 4D may relate to an apparatus order list associated with the configuration illustrated in FIG. 3D.

In the example of FIG. 4D, apparatus identifier 432 identifies a host apparatus and each of apparatus identifiers 434, 436, and 438 identify a separate apparatus. In the example of FIG. 4D, the apparatus order list may comprise apparatus identifiers 434, 436, and 438 based, at least in part, on a determination that the separate apparatuses identified by apparatus identifiers 434, 436, and 438 each relate to a separate apparatus proximate to an apparatus identified by apparatus identifier 432. In the example of FIG. 4D, the apparatus order list may indicate rendering of a media item associated with apparatus identifier 434, followed by rendering of a media item associated with apparatus identifier 432, followed by rendering of a media item associated with apparatus identifier 438, and followed by rendering of a media item associated with apparatus identifier 436.

In the example of FIG. 4D, the apparatus order list may be based, at least in part, on an input indicative of a change of an apparatus order list associated with reversal of order at a separate apparatus associated with apparatus identifier 406 of FIG. 4A. For example, an apparatus order list may be caused to change from an order indicative of rendering of media item candidates in an order of association with apparatus identifiers 432, 434, 436, and 438, the rendering order reverses at apparatus identifier 436 such that the different apparatus order list indicates rendering of media item candidates in an order of association with apparatus identifiers 434, 432, 438, and 436.

FIG. 4E is a diagram illustrating apparatus association according to at least one example embodiment. The example of FIG. 4E relates to an apparatus order list comprising references to media item candidates. In the example of FIG. 4E, two media item candidates will be caused to render from an apparatus and each separate apparatus proximate to the apparatus. In the example of FIG. 4E, apparatus identifier 442 identifies a host apparatus and each of apparatus identifiers 444, 446, and 448 identify a separate apparatus. Apparatus identifier 442 is associated with media items 442A and 442B, apparatus identifier 444 is associated with media items 444A and 444B, identifier 446 is associated with media items 446A and 446B, and identifier 448 is associated with media items 448A and 448B. In the example of FIG. 4E, media item candidates may be rendered such that two media item candidates are rendered per apparatus and/or separate apparatus prior to moving to a next apparatus and/or separate apparatus based, at least in part, on the apparatus order list.

FIG. 4F is a diagram illustrating apparatus association according to at least one example embodiment. The example of FIG. 4F relates to rendering of media item candidates illustrated in FIG. 3A. Such rendering may, for example, be performed in a structured manner such that one media item candidate associated with each apparatus and/or separate apparatus is caused to be rendered prior to rendering of a next media item candidate associated with a next apparatus and/or separate apparatus. Such rendering may, for example, be performed until exhaustion of media item candidates associated with the apparatus and/or the separate apparatus.

In the example of FIG. 4F, apparatus identifiers 462, 464, 466, and 468 may identify apparatus 302, 304, 306, and 308 of FIG. 3A, respectively. In the example of FIG. 4F, a first round of rendering comprises rendering media item 462A associated with apparatus identifier 462, followed by rendering media item 464A associated with apparatus identifier 464, followed by rendering media item 466A associated with apparatus identifier 466, and followed by rendering media item 468A associated with apparatus identifier 468. In the example of FIG. 4F, a second round of rendering comprises rendering media item 462B associated with apparatus identifier 462, followed by rendering media item 464B associated with apparatus identifier 464, followed by rendering media item 466B associated with apparatus identifier 466, and followed by rendering media item 468B associated with apparatus identifier 468. As apparatus 306 of FIG. 3A is associated with only two media item candidates, media items 326A and 326B, the media item candidates have been exhaustively rendered after the second round of rendering. Thus, in at least one example, after causing rendering of all media item candidates associated with an apparatus and/or a separate apparatus, the apparatus and/or the separate apparatus are skipped in subsequent rounds of rendering. In the example of FIG. 4F, a third round of rendering comprises rendering media item 462C associated with apparatus identifier 462, followed by rendering media item 464C associated with apparatus identifier 464, and followed by rendering media item 468C associated with apparatus identifier 468. As apparatus 302 of FIG. 3A is associated with only three media item candidates, media items 322A, 322B, and 322C, the associated media item candidates have been exhaustively rendered after the third round of rendering. In the example of FIG. 4F, a fourth round of rendering comprises rendering media item 464D associated with apparatus identifier 464, and followed by rendering media item 468D associated with apparatus identifier 468. As apparatus 306 of FIG. 3A is associated with only four media item candidates, media items 326A, 326B, 326C, and 326D, the associated media item candidates have been exhaustively rendered after the fourth round of rendering. In the example of FIG. 4F, a fifth and final round of rendering comprises rendering media item 468E associated with apparatus identifier 468. Based, at least in part, on exhaustively rendering all media item candidates associated with the apparatus and the separate apparatuses, rendering of media item candidates may be caused to terminate.

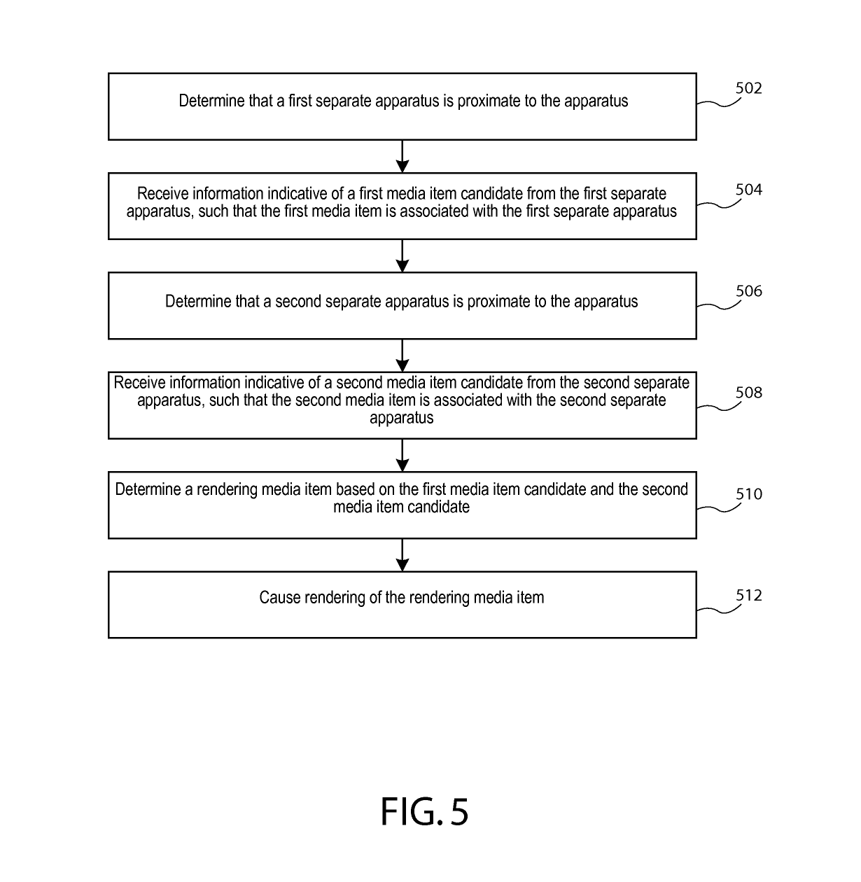

FIG. 5 is a flow diagram illustrating activities associated with causing rendering of a rendering media item according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

At block 502, the apparatus determines that a first separate apparatus is proximate to the apparatus. The determination, the first separate apparatus, and the proximity to the apparatus may be similar as described regarding FIGS. 2A-2B, FIGS. 3A-3D, and FIGS. 4A-4F.

At block 504, the apparatus receives information indicative of a first media item candidate from the first separate apparatus, such that the first media item is associated with the first separate apparatus. The receipt, the information indicative of the first media item candidate, and the association between the first media item and the first separate apparatus may be similar as described regarding FIGS. 2A-2B, FIGS. 3A-3D, and FIGS. 4A-4F.

At block 506, the apparatus determines that a second separate apparatus is proximate to the apparatus. The determination, the second separate apparatus, and the proximity to the apparatus may be similar as described regarding FIGS. 2A-2B, FIGS. 3A-3D, and FIGS. 4A-4F.

At block 508, the apparatus receives information indicative of a second media item candidate from the second separate apparatus, such that the second media item is associated with the second separate apparatus. The receipt, the information indicative of the second media item candidate, and the association between the second media item and the second separate apparatus may be similar as described regarding FIGS. 2A-2B, FIGS. 3A-3D, and FIGS. 4A-4F.

At block 510, the apparatus determines a rendering media item based, at least in part, on the first media item candidate and the second media item candidate. The determination and the rendering media item may be similar as described regarding FIGS. 3A-3D and FIGS. 4A-4F.

At block 512, the apparatus causes rendering of the rendering media item. The causation and the rendering of the rendering media item may be similar as described regarding FIGS. 2A-2B, FIGS. 3A-3D, and FIGS. 4A-4F.

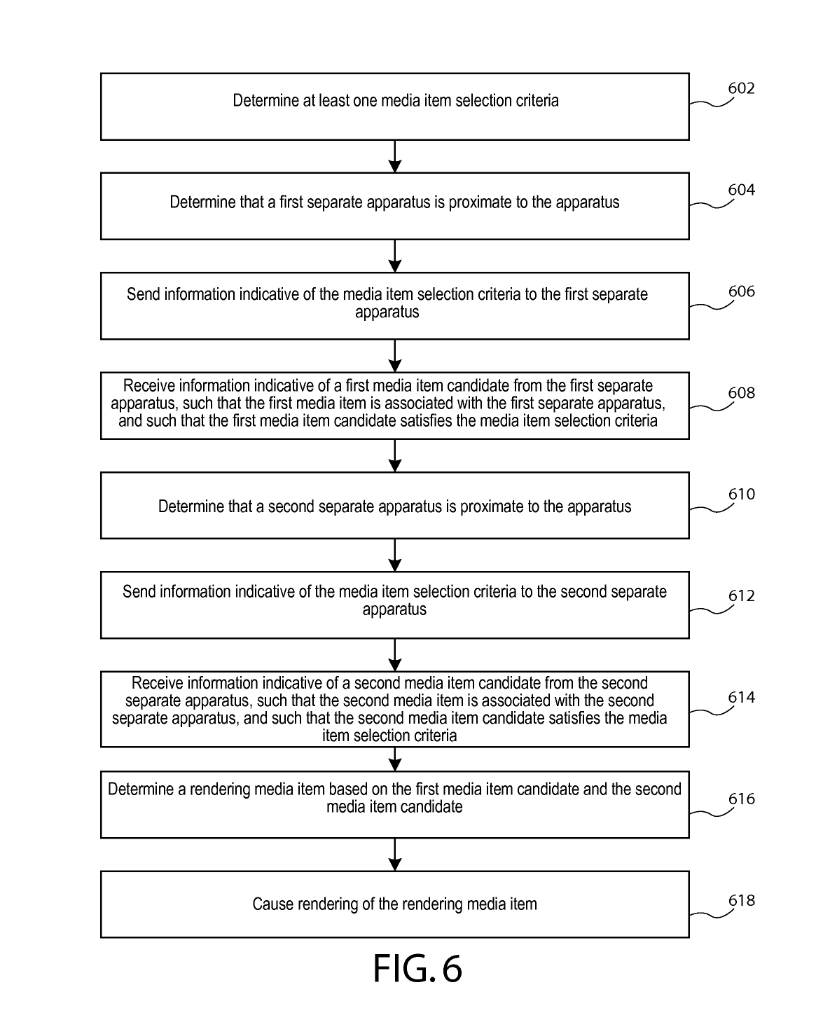

FIG. 6 is a flow diagram illustrating activities associated with causing rendering of a rendering media item according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus determines at least one media item selection criteria. The determination and the media item selection criteria may be similar as described regarding FIGS. 3A-3D and FIGS. 4A-4F.

At block 604, the apparatus determines that a first separate apparatus is proximate to the apparatus, similar as described regarding block 502 of FIG. 5.

At block 606, the apparatus sends information indicative of the media item selection criteria to the first separate apparatus. The sending and the information indicative of the media item selection criteria may be similar as described regarding FIGS. 2A-2B, FIGS. 3A-3D, and FIGS. 4A-4F.

At block 608, the apparatus receives information indicative of a first media item candidate from the first separate apparatus, such that the first media item is associated with the first separate apparatus, and such that the first media item candidate satisfies the media item selection criteria. The receipt, the information indicative of the first media item candidate, the association between the first media item and the first separate apparatus, and the satisfaction of the media item selection criteria may be similar as described regarding FIGS. 2A-2B, FIGS. 3A-3D, and FIGS. 4A-4F.

At block 610, the apparatus determines that a second separate apparatus is proximate to the apparatus, similar as described regarding block 506 of FIG. 5.

At block 612, the apparatus sends information indicative of the media item selection criteria to the second separate apparatus. The sending and the information indicative of the media item selection criteria may be similar as described regarding FIGS. 2A-2B, FIGS. 3A-3D, and FIGS. 4A-4F.

At block 614, the apparatus receives information indicative of a second media item candidate from the second separate apparatus, such that the second media item is associated with the second separate apparatus, and such that the second media item candidate satisfies the media item selection criteria. The receipt, the information indicative of the second media item candidate, the association between the second media item and the second separate apparatus, and the satisfaction of the media item selection criteria may be similar as described regarding FIGS. 2A-2B, FIGS. 3A-3D, and FIGS. 4A-4F.

At block 616, the apparatus determines a rendering media item based, at least in part, on the first media item candidate and the second media item candidate. The determination and the rendering media item may be similar as described regarding FIGS. 3A-3D and FIGS. 4A-4F.

At block 618, the apparatus causes rendering of the rendering media item, similar as described regarding block 512 of FIG. 5.

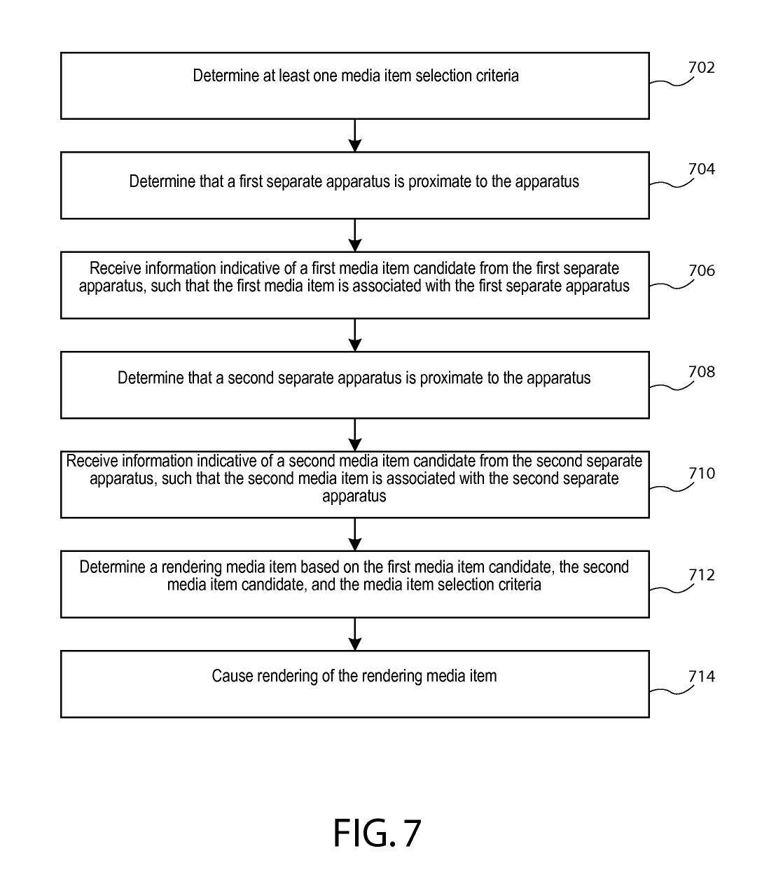

FIG. 7 is a flow diagram illustrating activities associated with causing rendering of a rendering media item according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

At block 702, the apparatus determines at least one media item selection criteria. The determination and the media item selection criteria may be similar as described regarding FIGS. 3A-3D and FIGS. 4A-4F.

At block 704, the apparatus determines that a first separate apparatus is proximate to the apparatus, similar as described regarding block 502 of FIG. 5.

At block 706, the apparatus receives information indicative of a first media item candidate from the first separate apparatus, such that the first media item is associated with the first separate apparatus. The receipt, the information indicative of the first media item candidate, and the association between the first media item and the first separate apparatus may be similar as described regarding FIGS. 2A-2B, FIGS. 3A-3D, and FIGS. 4A-4F.

At block 708, the apparatus determines that a second separate apparatus is proximate to the apparatus, similar as described regarding block 506 of FIG. 5.

At block 710, the apparatus receives information indicative of a second media item candidate from the second separate apparatus, such that the second media item is associated with the second separate apparatus. The receipt, the information indicative of the second media item candidate, and the association between the second media item and the second separate apparatus may be similar as described regarding FIGS. 2A-2B, FIGS. 3A-3D, and FIGS. 4A-4F.

At block 712, the apparatus determines a rendering media item based, at least in part, on the first media item candidate, the second media item candidate, and the media item selection criteria. The determination and the rendering media item may be similar as described regarding FIGS. 3A-3D and FIGS. 4A-4F.

At block 714, the apparatus causes rendering of the rendering media item, similar as described regarding block 512 of FIG. 5.

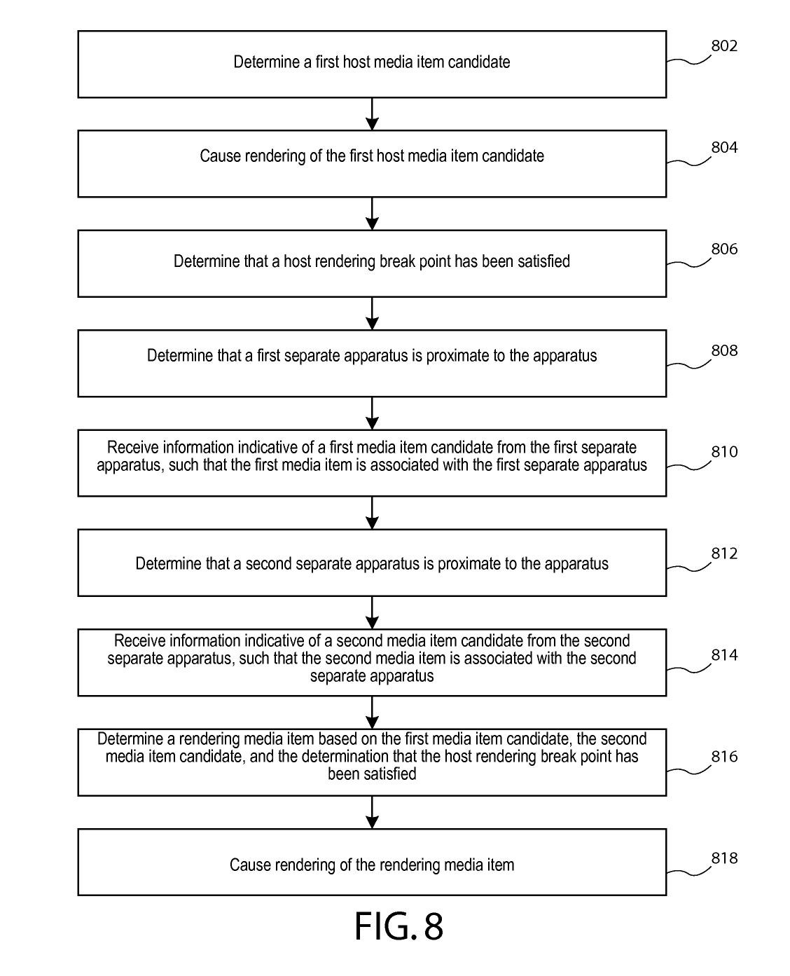

FIG. 8 is a flow diagram illustrating activities associated with causing rendering of a rendering media item according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

At block 802, the apparatus determines a first host media item candidate. The determination and the first host media item candidate may be similar as described regarding FIGS. 3A-3D and FIGS. 4A-4F.

At block 804, the apparatus causes rendering of the first host media item candidate. The causation and the rendering of the first host media item candidate may be similar as described regarding FIGS. 2A-2B, FIGS. 3A-3D, and FIGS. 4A-4F.

At block 806, the apparatus determines that a host rendering break point has been satisfied. The determination, the host rendering break point, and the satisfaction of the host rendering break point may be similar as described regarding FIGS. 3A-3D and FIGS. 4A-4F.

At block 808, the apparatus determines that a first separate apparatus is proximate to the apparatus, similar as described regarding block 502 of FIG. 5.

At block 810, the apparatus receives information indicative of a first media item candidate from the first separate apparatus, such that the first media item is associated with the first separate apparatus, similar as described regarding block 504 of FIG. 5.

At block 812, the apparatus determines that a second separate apparatus is proximate to the apparatus, similar as described regarding block 506 of FIG. 5.

At block 814, the apparatus receives information indicative of a second media item candidate from the second separate apparatus, such that the second media item is associated with the second separate apparatus, similar as described regarding block 508 of FIG. 5.

At block 816, the apparatus determines a rendering media item based, at least in part, on the first media item candidate, the second media item candidate, and the determination that the host rendering break point has been satisfied. The determination, the rendering media item, and the determination that the host rendering break point has been satisfied may be similar as described regarding FIGS. 3A-3D and FIGS. 4A-4F.

At block 818, the apparatus causes rendering of the rendering media item, similar as described regarding block 512 of FIG. 5.

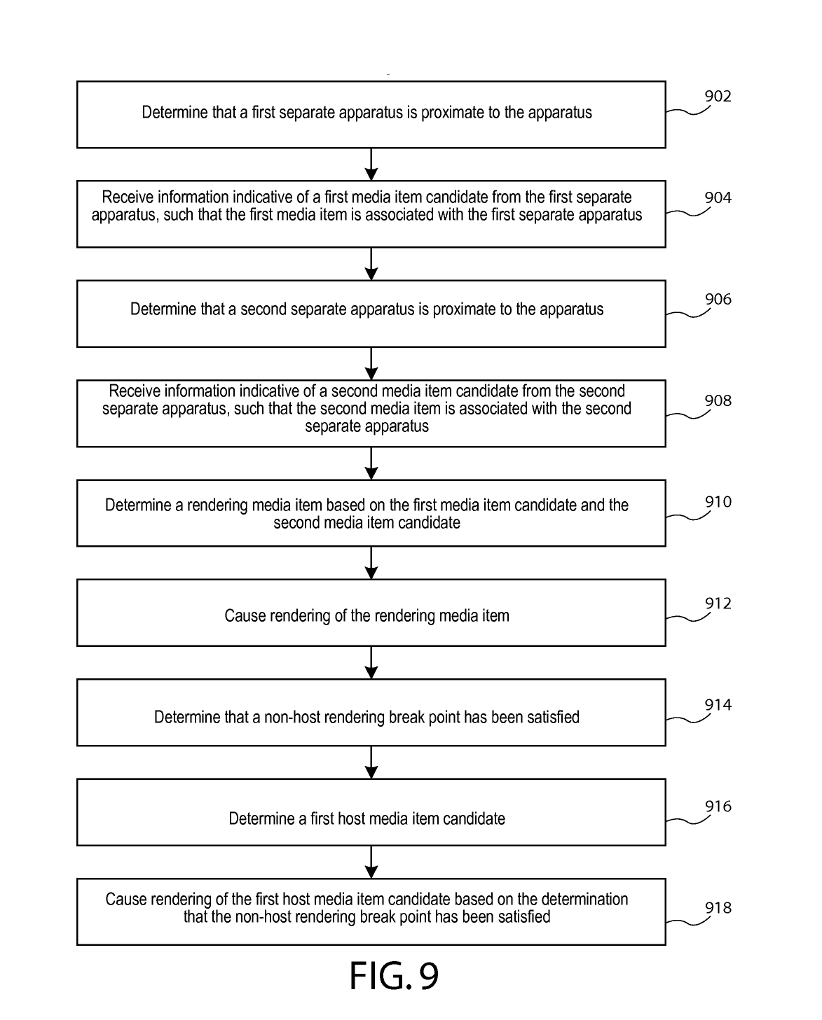

FIG. 9 is a flow diagram illustrating activities associated with causing rendering of a rendering media item according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

At block 902, the apparatus determines that a first separate apparatus is proximate to the apparatus, similar as described regarding block 502 of FIG. 5.

At block 904, the apparatus receives information indicative of a first media item candidate from the first separate apparatus, such that the first media item is associated with the first separate apparatus, similar as described regarding block 504 of FIG. 5.

At block 906, the apparatus determines that a second separate apparatus is proximate to the apparatus, similar as described regarding block 506 of FIG. 5.

At block 908, the apparatus receives information indicative of a second media item candidate from the second separate apparatus, such that the second media item is associated with the second separate apparatus, similar as described regarding block 508 of FIG. 5.

At block 910, the apparatus determines a rendering media item based, at least in part, on the first media item candidate and the second media item candidate, similar as described regarding block 510 of FIG. 5.

At block 912, the apparatus causes rendering of the rendering media item, similar as described regarding block 512 of FIG. 5.

At block 914, the apparatus determines that a non-host rendering break point has been satisfied. The determination, the non-host rendering break point, and the satisfaction of the non-host rendering break point may be similar as described regarding FIGS. 3A-3D and FIGS. 4A-4F.

At block 916, the apparatus determines a first host media item candidate. The determination and the first host media item candidate may be similar as described regarding FIGS. 3A-3D and FIGS. 4A-4F.

At block 918, the apparatus causes rendering of the first host media item candidate based, at least in part, on the determination that the non-host rendering break point has been satisfied. The causation and the rendering of the first host media item candidate may be similar as described regarding FIGS. 2A-2B, FIGS. 3A-3D, and FIGS. 4A-4F.

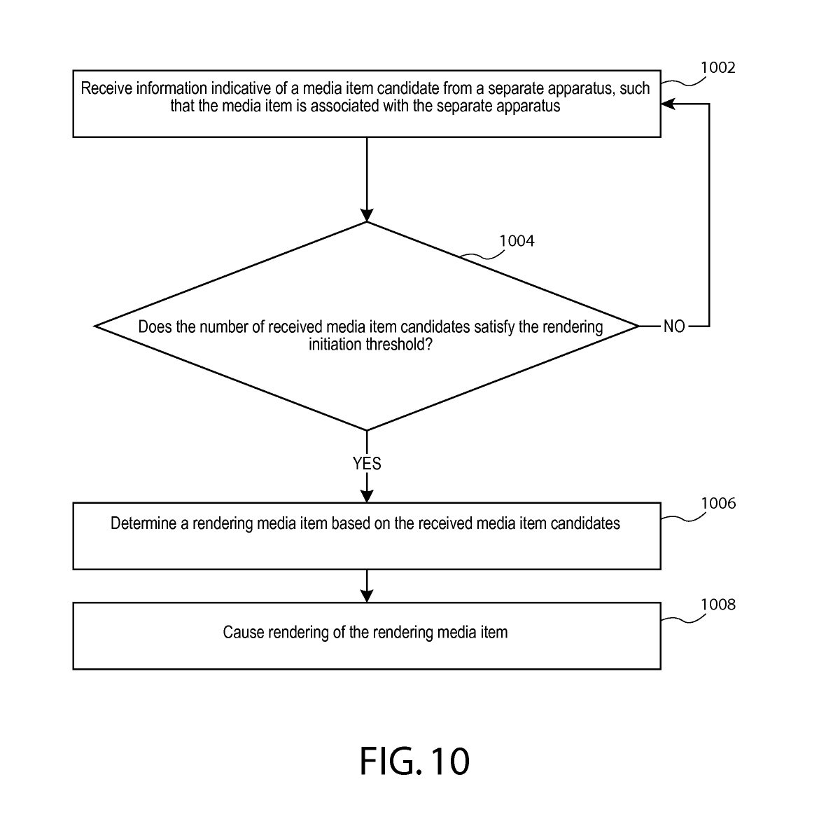

FIG. 10 is a flow diagram illustrating activities associated with causing rendering of a rendering media item according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

In some circumstances, it may be desirable to delay rendering of media item candidates until a predetermined number of media item candidates have been received by an apparatus. For example, in order to facilitate group consumption of media items, a user may desire to aggregate a predetermined number of songs, images, and/or videos prior to rendering of a playlist, slideshow, and/or the like. In at least one example embodiment, an apparatus determines that a number of media item candidates satisfies a rendering initiation threshold. In such an example embodiment, determination of a rendering media item may be caused by the determination that the number of media item candidates satisfies the rendering initiation threshold. In at least one example embodiment, an apparatus receives indication of a first media item candidate and a second media item candidate. In such an example embodiment, a number of media item candidates may be based, at least in part, on the first media item candidate and the second media item candidate. For example, the number of media item candidates may include increments associated with the first media item candidate and the second media item candidate.

At block 1002, the apparatus receives information indicative of a media item candidate from a separate apparatus, such that the media item is associated with the separate apparatus. The receipt, the information indicative of the media item candidate, the separate apparatus, and the association between the media item and the separate apparatus may be similar as described regarding FIGS. 2A-2B, FIGS. 3A-3D, and FIGS. 4A-4F.

At block 1004, the apparatus determines whether a number of received media item candidates satisfies a rendering initiation threshold. The determination, the number of received media item candidates, the rendering initiation threshold, and satisfaction of the rendering initiation threshold may be similar as described regarding FIGS. 3A-3D and FIGS. 4A-4F.

At block 1006, the apparatus determines a rendering media item based, at least in part, on the received media item candidates. The determination, the rendering media item, and the received media item candidates may be similar as described regarding FIGS. 3A-3D and FIGS. 4A-4F.

At block 1008, the apparatus causes rendering of the rendering media item, similar as described regarding block 512 of FIG. 5.

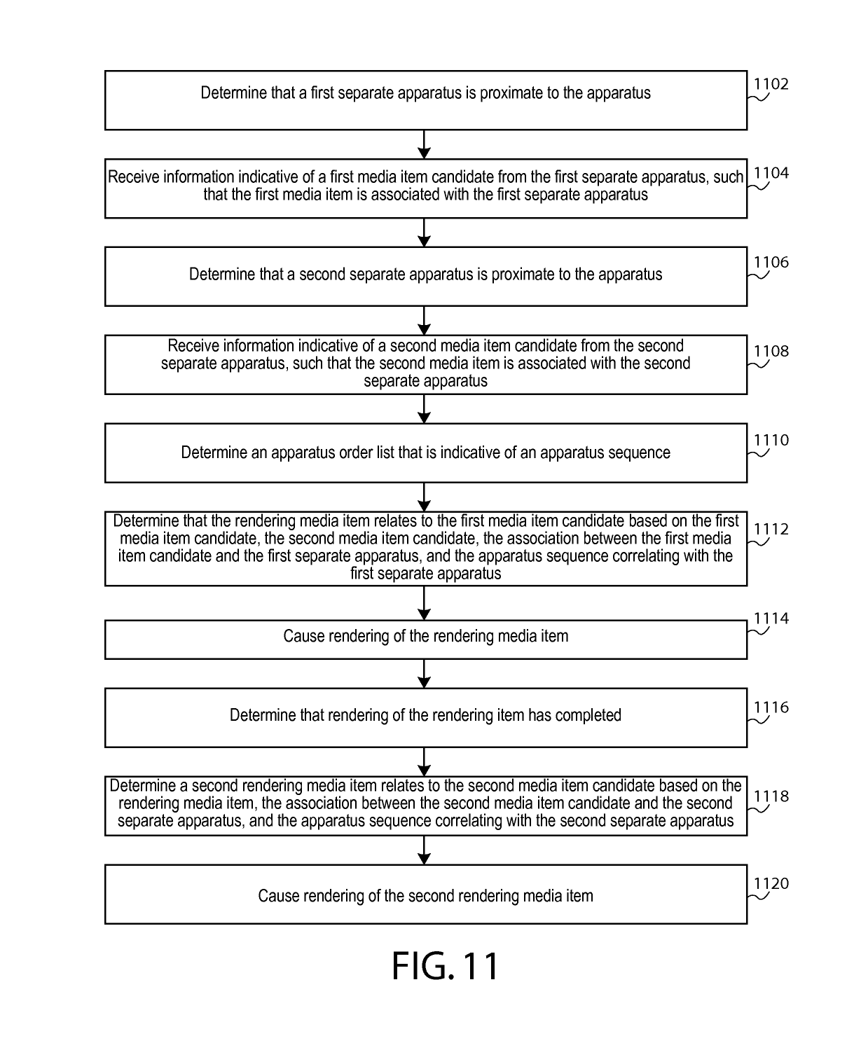

FIG. 11 is a flow diagram illustrating activities associated with causing rendering of a rendering media item according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

At block 1102, the apparatus determines that a first separate apparatus is proximate to the apparatus, similar as described regarding block 502 of FIG. 5.

At block 1104, the apparatus receives information indicative of a first media item candidate from the first separate apparatus, such that the first media item is associated with the first separate apparatus, similar as described regarding block 504 of FIG. 5.

At block 1106, the apparatus determines that a second separate apparatus is proximate to the apparatus, similar as described regarding block 506 of FIG. 5.

At block 1108, the apparatus receives information indicative of a second media item candidate from the second separate apparatus, such that the second media item is associated with the second separate apparatus, similar as described regarding block 508 of FIG. 5.

At block 1110, the apparatus determines an apparatus order list that is indicative of an apparatus sequence. The determination, the apparatus order list, and the apparatus sequence may be similar as described regarding FIGS. 3A-3D and FIGS. 4A-4F.

At block 1112, the apparatus determines that the rendering media item relates to the first media item candidate based, at least in part, on the first media item candidate, the second media item candidate, the association between the first media item candidate and the first separate apparatus, and the apparatus sequence correlating with the first separate apparatus. The determination, the rendering media item, the relation of the rendering media item and the first media item candidate, the association between the first media item candidate and the first separate apparatus, and the apparatus sequence correlating with the first separate apparatus may be similar as described regarding FIGS. 3A-3D and FIGS. 4A-4F.

At block 1114, the apparatus causes rendering of the rendering media item, similar as described regarding block 512 of FIG. 5.

At block 1116, the apparatus determines that rendering of the rendering media item has completed. The determination, the rendering, and the completion of rendering the rendering media item may be similar as described regarding FIGS. 3A-3D and FIGS. 4A-4F.

At block 1118, the apparatus determines a second rendering media item relates to the second media item candidate based, at least in part, on the rendering media item, the association between the second media item candidate and the second separate apparatus, and the apparatus sequence correlating with the second separate apparatus. The determination, the second rendering media item, the relation of the second rendering media item and the second media item candidate, the association between the second media item candidate and the second separate apparatus, and the apparatus sequence correlating with the second separate apparatus may be similar as described regarding FIGS. 3A-3D and FIGS. 4A-4F.

At block 1120, the apparatus causes rendering of the second rendering media item. The causation and the rendering of the second rendering media item may be similar as described regarding FIGS. 2A-2B, FIGS. 3A-3D, and FIGS. 4A-4F.

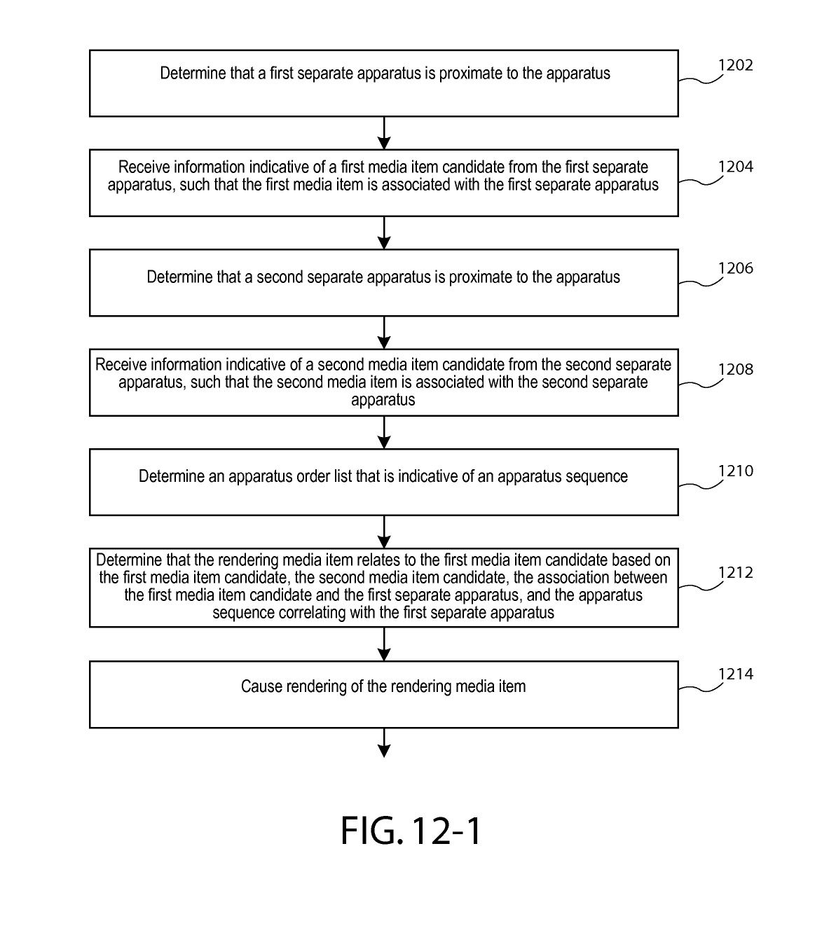

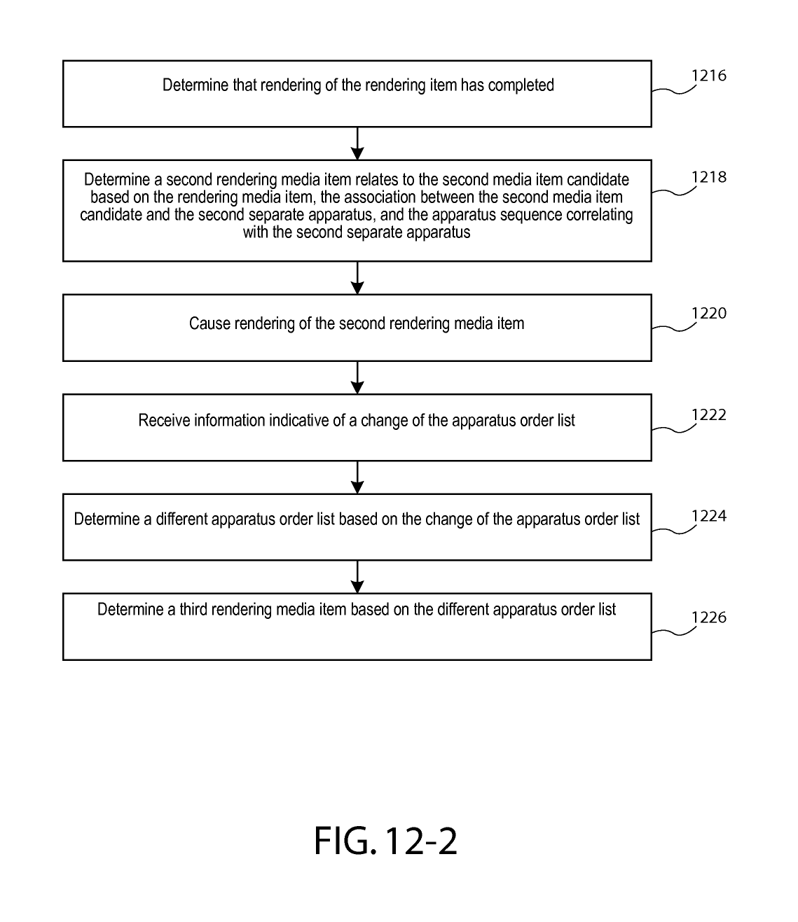

FIG. 12 is a flow diagram illustrating activities associated with causing rendering of a rendering media item according to at least one example embodiment. In at least one example embodiment, there is a set of operations that corresponds with the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

At block 1202, the apparatus determines that a first separate apparatus is proximate to the apparatus, similar as described regarding block 502 of FIG. 5.

At block 1204, the apparatus receives information indicative of a first media item candidate from the first separate apparatus, such that the first media item is associated with the first separate apparatus, similar as described regarding block 504 of FIG. 5.

At block 1206, the apparatus determines that a second separate apparatus is proximate to the apparatus, similar as described regarding block 506 of FIG. 5.

At block 1208, the apparatus receives information indicative of a second media item candidate from the second separate apparatus, such that the second media item is associated with the second separate apparatus, similar as described regarding block 508 of FIG. 5.

At block 1210, the apparatus determines an apparatus order list that is indicative of an apparatus sequence, similar as described regarding block 1110 of FIG. 11.

At block 1212, the apparatus determines that the rendering media item relates to the first media item candidate based, at least in part, on the first media item candidate, the second media item candidate, the association between the first media item candidate and the first separate apparatus, and the apparatus sequence correlating with the first separate apparatus, similar as described regarding block 1112 of FIG. 11.

At block 1214, the apparatus causes rendering of the rendering media item, similar as described regarding block 512 of FIG. 5.

At block 1216, the apparatus determines that rendering of the rendering media item has completed, similar as described regarding block 1116 of FIG. 11.

At block 1218, the apparatus determines a second rendering media item relates to the second media item candidate based, at least in part, on the rendering media item, the association between the second media item candidate and the second separate apparatus, and the apparatus sequence correlating with the second separate apparatus, similar as described regarding block 1118 of FIG. 11.

At block 1220, the apparatus causes rendering of the second rendering media item, similar as described regarding block 1120 of FIG. 11.

At block 1222, the apparatus receives information indicative of a change of the apparatus order list. The receipt, the information indicative, and the change of the apparatus order list may be similar as described regarding FIGS. 2A-2B, FIGS. 3A-3D, and FIGS. 4A-4F.

At block 1224, the apparatus determines a different apparatus order list based, at least in part, on the change of the apparatus order list. The determination, the different apparatus order list, and the change of the apparatus order list may be similar as described regarding FIGS. 3A-3D and FIGS. 4A-4F.

At block 1226, the apparatus determines a third rendering media item based, at least in part, on the different apparatus order list. The determination and the third rendering media item may be similar as described regarding FIGS. 3A-3D and FIGS. 4A-4F.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 504 of FIG. 5 may be performed after block 506 of FIG. 5. Furthermore, if desired, one or more of the above-described functions may be optional or may be combined. For example, block 1116 of FIG. 11 may be optional and/or combined with block 1114 of FIG. 11.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
determine that a first separate apparatus is proximate to the apparatus;
receive information indicative of a first media item candidate from the first separate apparatus, such that the first media item is associated with the first separate apparatus;
determine that a second separate apparatus is proximate to the apparatus;
receive information indicative of a second media item candidate from the second separate apparatus, such that the second media item is associated with the second separate apparatus;
determine a rendering media item based, at least in part, on the first media item candidate and the second media item candidate; and
cause rendering of the rendering media item.

2. The apparatus of claim 1, wherein determination of the rendering media item comprises determination that the rendering media item relates to the first media item candidate based, at least in part, on the association between the first media item candidate and the first separate apparatus.

3. The apparatus of claim 2, wherein the memory includes computer program code configured to, working with the processor, cause the apparatus to perform:
determination that rendering of the rendering item has completed;
determination of a second rendering media item to relate to the second media item candidate based, at least in part, on the rendering media item and the association between the second media item candidate and the second separate apparatus; and
causation of rendering of the second rendering media item.

4. The apparatus of claim 3, wherein the memory includes computer program code configured to, working with the processor, cause the apparatus to perform determination of an apparatus order list that is indicative of an apparatus sequence, wherein the determination of the rendering media item is further based, at least in part, on the apparatus sequence correlating with the first separate apparatus and the determination of the second rendering media item is further based, at least in part, on the apparatus sequence correlating with the second separate apparatus.

5. The apparatus of claim 4, wherein determination of the apparatus order list is based, at least in part, on a predetermined apparatus order.

6. The apparatus of claim 5, wherein the memory includes computer program code configured to, working with the processor, cause the apparatus to perform receipt of information indicative of the predetermined apparatus order, the information indicative of the predetermined apparatus order relating to one or more inputs.

7. The apparatus of claim 4, wherein determination of the apparatus order list is based, at least in part, on a ranking of distance between the apparatus and a separate apparatus represented in the apparatus order list.

8. The apparatus of claim 4, wherein the memory includes computer program code configured to, working with the processor, cause the apparatus to perform:
receipt of information indicative of a change of the apparatus order list;
determination of a different apparatus order list based, at least in part, on the change of the apparatus order list; and
determination of a third rendering media item based, at least in part, on the different apparatus order list.

9. The apparatus of claim 1, wherein the apparatus comprises a display.

10. A method comprising:
determining that a first separate apparatus is proximate to the apparatus;
receiving information indicative of a first media item candidate from the first separate apparatus, such that the first media item is associated with the first separate apparatus;
determining that a second separate apparatus is proximate to the apparatus;
receiving information indicative of a second media item candidate from the second separate apparatus, such that the second media item is associated with the second separate apparatus;
determining a rendering media item based, at least in part, on the first media item candidate and the second media item candidate; and
causing rendering of the rendering media item.

11. The method of claim 10, wherein determination of the rendering media item comprises determination that the rendering media item relates to the first media item candidate based, at least in part, on the association between the first media item candidate and the first separate apparatus.

12. The method of claim 11, further comprising:
determining that rendering of the rendering item has completed;
determining a second rendering media item to relate to the second media item candidate based, at least in part, on the rendering media item and the association between the second media item candidate and the second separate apparatus; and
causing rendering of the second rendering media item.

13. The method of claim 12, further comprising determining an apparatus order list that is indicative of an apparatus sequence, wherein the determination of the rendering media item is further based, at least in part, on the apparatus sequence correlating with the first separate apparatus and the determination of the second rendering media item is further based, at least in part, on the apparatus sequence correlating with the second separate apparatus.

14. The method of claim 13, wherein determination of the apparatus order list is based, at least in part, on a predetermined apparatus order.

15. The method of claim 13, wherein determination of the apparatus order list is based, at least in part, on a ranking of distance between the apparatus and a separate apparatus represented in the apparatus order list.

16. The method of claim 13, further comprising:
receiving information indicative of a change of the apparatus order list;
determining a different apparatus order list based, at least in part, on the change of the apparatus order list; and
determining a third rendering media item based, at least in part, on the different apparatus order list.

17. At least one computer-readable medium encoded with instructions that, when executed by a processor, perform:
determining that a first separate apparatus is proximate to the apparatus;
receiving information indicative of a first media item candidate from the first separate apparatus, such that the first media item is associated with the first separate apparatus;
determining that a second separate apparatus is proximate to the apparatus;
receiving information indicative of a second media item candidate from the second separate apparatus, such that the second media item is associated with the second separate apparatus;
determining a rendering media item based, at least in part, on the first media item candidate and the second media item candidate; and
causing rendering of the rendering media item.

18. The medium of claim 17, wherein determination of the rendering media item comprises determination that the rendering media item relates to the first media item candidate based, at least in part, on the association between the first media item candidate and the first separate apparatus.

19. The medium of claim 18, wherein the medium is further encoded with instructions that, when executed by the processor, perform:
determining that rendering of the rendering item has completed;
determining a second rendering media item to relate to the second media item candidate based, at least in part, on the rendering media item and the association between the second media item candidate and the second separate apparatus; and
causing rendering of the second rendering media item.

20. The medium of claim 18, wherein the medium is further encoded with instructions that, when executed by the processor, perform determining an apparatus order list that is indicative of an apparatus sequence, wherein the determination of the rendering media item is further based, at least in part, on the apparatus sequence correlating with the first separate apparatus and the determination of the second rendering media item is further based, at least in part, on the apparatus sequence correlating with the second separate apparatus.
